(19) United States
(12) Patent Application Publication
(10) Pub. No.: US 2025/0021622 A1
(43) Pub. Date: Jan. 16, 2025

(54) EFFICIENT VECTOR-MATRIX MULTIPLY OPERATIONS ACROSS PARALLEL PROCESSING UNIT THREADS

(71) Applicant: NVIDIA Corporation, Santa Clara, CA (US)

(72) Inventors: Sean Jeffrey Treichler, Piedmont, CA (US); Yury Uralsky, Los Gatos, CA (US); Karthik Vaidyanathan, Oakland, CA (US); Franz Petrik Clarberg, Lund (SE); Jeffrey Alan Bolz, Cedar Park, TX (US); John Matthew Burgess, Austin, TX (US); Ajay Sudarshan Tirumala, San Jose, CA (US)

(21) Appl. No.: 18/769,710

(22) Filed: Jul. 11, 2024

Related U.S. Application Data
(60) Provisional application No. 63/526,333, filed on Jul. 12, 2023.

(51) Int. Cl. G06F 17/16

(52) U.S. Cl. CPC G06F 17/16

(57) ABSTRACT

Disclosed are systems and techniques for efficient vector-matrix multiply operations across parallel processing unit threads. The techniques include receiving first data of a first thread, the first data comprising a first input vector and a first matrix. The techniques further include receiving second data of a second thread, the second data comprising a second input vector and a second matrix. The techniques further include combining the first input vector and the second input vector into an input matrix and generating a result matrix at least by multiplying the input matrix by the first matrix using a matrix-multiply circuit. The techniques further include separating the result matrix into a first result value and a second result value, the first result value corresponding to the first thread and the second result value corresponding to the second thread.

### RELATED APPLICATION

The application claims the benefit of U.S. Provisional Patent Application No. 63/526,333, filed Jul. 12, 2023, entitled “Programming Model for Deep Learning Inference and Training”, the contents of which are incorporated by reference in their entirety herein.

### TECHNICAL FIELD

At least one embodiment pertains to parallel execution of threads by a parallel processing unit, and more specifically to parallel execution of vector-matrix multiply operations across parallel processing unit threads.

### BACKGROUND

Parallel processing units can be components of a computer system designed to perform multiple operations or tasks simultaneously, enhancing computational speed and efficiency. They can work by dividing complex problems into smaller ones, distributing these across multiple processing elements that operate concurrently. Common examples include multi-core processors, graphics processing units (GPUs), and field-programmable gate arrays (FPGAs). Parallel processing units can be used for high-performance computing tasks, such as data analysis, scientific simulations, and graphics rendering, which can include vertex processing, rasterization, fragment processing, ray tracing, and the like.

### BRIEF DESCRIPTION OF THE DRAWINGS

FIG. 1 is a block diagram of an example computer system for efficient vector-matrix multiply operations across parallel processing unit threads, according to at least one embodiment;

FIG. 2 is a block diagram of an example data flow for efficient vector-matrix multiply operations across parallel processing unit threads, according to at least one embodiment;

FIG. 3 is a block diagram of an example data flow for efficient vector-vector multiply operations across parallel processing unit threads, according to at least one embodiment;

FIG. 4 is a block diagram of an example data flow for efficient vector-matrix multiply operations, according to at least one embodiment;

FIG. 5 is a block diagram of an example shuffled memory layout for efficient vector-matrix multiply operations across parallel processing unit threads, according to at least one embodiment;

FIG. 6 is a block diagram of an example thread manipulation for efficient vector-matrix multiply operations across parallel processing unit threads, according to at least one embodiment;

FIG. 7 is a flow diagram of an example method for efficient vector-matrix multiply operations across parallel processing unit threads, according to at least one embodiment;

FIG. 8 is a flow diagram of an example method for compiling executable code for efficient vector-matrix multiply operations across parallel processing unit threads, according to at least one embodiment;

FIG. 9 is a block diagram illustrating an exemplary computer system, in accordance with at least one embodiment of the present disclosure;

FIG. 10A illustrates inference and/or training logic, according to at least one embodiment of the present disclosure;

FIG. 10B illustrates inference and/or training logic, according to at least one embodiment;

FIG. 11 illustrates training and deployment of a neural network, according to at least one embodiment;

FIG. 12 is an example data flow diagram for an advanced computing pipeline, according to at least one embodiment; and

FIG. 13 is a system diagram for an example system for training, adapting, instantiating and deploying machine learning models in an advanced computing pipeline, according to at least one embodiment.

### DETAILED DESCRIPTION

Some graphics rendering tasks (e.g., shading, texture rendering, ray tracing, etc.) can be performed by evaluating a small neural network using the graphics element(s) (e.g., pixels, rays, vertices, etc.) as inputs. The neural network can be a multi-layer perceptron (MLP) with a layer of input neurons, one or more “hidden” layers, and an output layer. Each neuron of the MLP can be expressed as a function of all neurons of the prior layer of the MLP. A MLP can be described as “L×N,” where L is the number of hidden layers and N is the number of neurons per hidden layer. Computing the output of a given layer involves a matrix-vector multiply (e.g., N×N*N×1), optionally adding a bias vector, and evaluating an activation function (e.g., ReLU=max (x,0)). In the matrix-vector multiply operations, the matrix can represent weight coefficients of each pairing of one neuron from the current layer and one from the previous layer, and the vector can represent the output values of the previous layer of neurons.

Evaluating the MLP can be performed in real-time in a shader program of a parallel processing unit. However, current approaches cannot take advantage of specialized circuits (e.g., Tensor Cores) to efficiently evaluate the vector-matrix multiply operations across threads of a parallel processing unit because current approaches assume whole groups of threads are concurrently operating on blocks of data, which is incompatible with a Single Instruction-Multiple Thread (SIMT) programming model. Current approaches are also limited by any divergence (e.g., applying a first weight matrix for a first thread and a second weight matrix for a second thread) that may occur between threads during evaluation of the vector-matrix operations.

The present disclosure addresses these and other technological challenges by providing a system and techniques for efficient vector-matrix multiply operations across parallel processing unit threads. A compiler can receive a source code (e.g., written by a shader developer) identifying one or more vector-matrix multiply operations to be performed by a plurality of threads. The compiler can compile the source code into an executable code, as described in more detail below. In some embodiments, one or more of the vector-matrix multiply operations further includes a vector (e.g., bias vector) to be added to the result of the vector-matrix multiply operation. For example, the shader developer could write source code that evaluates a MLP for one or more graphics elements (e.g., pixels, rays, etc.). The MLP can include one or more layers, each layer having a corresponding weight matrix and optional bias vector. The input to the MLP can be a vector representation of a particular graphics element. A compiled version of the source code (e.g., executable code) can be executed by a parallel processing unit to evaluate multiple graphics elements in parallel (e.g., one graphics element per thread of the parallel processing unit).

The compiler can convert the source code into an executable code that includes instructions that cause the parallel processing unit to combine vectors from at least a subset of the one or more vector-matrix multiply operations into an input matrix. For example, a vector representation of a first graphics element can be combined with a vector representation of a second graphics element to form the input matrix. The executable code can also include instructions that cause the parallel processing unit to multiply the input matrix by a first matrix using a matrix-multiply circuit (e.g., a specialized circuit for matrix-matrix operations, a Tensor Core, etc.) to obtain a result matrix. The first matrix can correspond to at least a first vector-matrix multiply operation of the one or more vector-matrix multiply operations. For example, the first matrix can be a weight matrix of a first layer of a MLP that is being used to evaluate the graphics element. In some embodiments, the bias vectors of each layer of the MLP can be combined into a bias matrix which can be combined with (e.g., added to, subtracted from, etc.) the matrix resulting from the matrix-matrix multiply operation.

Thus, the executable code can cause the parallel processing unit to evaluate multiple vector-matrix operations simultaneously by combining the input vectors into an input matrix and performing a matrix-matrix multiply operation using a specialized circuit (e.g., Tensor Core) in a SIMT manner. The executable code can also include instructions that cause the parallel processing unit to separate the result matrix into a plurality of result values, each result value of the plurality of result values can correspond to a thread of the plurality of threads.

In some embodiments, a first graphics element will be evaluated using a first weight matrix (e.g., from a first MLP) and a second graphics element will be evaluated using a second weight matrix (e.g., from a second MLP). The executable code can include instructions that cause the parallel processing unit to perform a first matrix-matrix multiply operation using the input matrix and the first weight matrix and a second matrix-matrix multiply operation using the input matrix and the second weight matrix. The result matrix can include one or more vectors from the result of the first matrix-matrix multiply operation and one or more vectors from the result of the second matrix-matrix multiply operation.

In some embodiments, the executable code can include instructions that transform one or more matrices before multiplying them using the matrix-multiply circuit. For example, the input matrix can be transformed (e.g., shuffled) from an input format to a matrix-multiply format. The weight matrix can be transformed (e.g., shuffled) from an input format to a matrix-multiply format. In some embodiments, a particular vector (or input matrix) can be multiplied by multiple weight matrices (e.g., when the MLP includes more than one hidden layer). In some embodiments, the input matrix can be transformed into the matrix-multiply format before being multiplied by the weight matrix of the first layer of the MLP. In some embodiments, the result of the first matrix-matrix multiply operation (e.g., shuffled input matrix x (shuffled) weight matrix) can be provided as the input to the next matrix-matrix multiply operation without being unshuffled. In some embodiments, the output matrix of a matrix-matrix multiply operation can be unshuffled (e.g., transformed from the matrix-multiply format to the input format) only after each layer of the MLP has been evaluated.

In some embodiments, the executable code can include instructions that add one or more padding values to the input matrix and/or the weight matrix to make the matrices compatible with the matrix-multiply circuit. For example, a first executable code compiled from a source code for execution on a first parallel processing unit can include instructions to pad one or more matrices before execution by the matrix-multiply circuit of the first parallel processor and a second executable code compiled from the same source code for execution on a second parallel processing unit can include different (or none) instructions to pad one or more matrices before execution by the matrix-multiply circuit of the second parallel processor.

In some embodiments, values of the input matrix can have a first numeric format (e.g., bit length, etc.) and values of the weight matrix can have a second numeric format (e.g., bit length, etc.) different than the first numeric format. The executable code can include instructions to evaluate the values of the input matrix based on the numeric format of the values of the weight matrix. For example, the compiler can generate instructions to perform an implicit type conversion, such as causing 16-bit floating point (FP16) input values to be multiplied by a matrix with 8-bit floating point (FP8) values.

In some embodiments, the executable code can include instructions that cause the parallel processing unit to perform vector-vector multiply operations in a SIMT manner. For example, during training of a MLP (e.g., backpropagation), it can be beneficial to calculate the outer product of an error vector (e.g., loss vector) and an activation vector. The vectors from multiple threads can be combined into matrices, which can in turn be multiplied efficiently using the matrix-multiply circuit discussed above. It should be understood that a vector-matrix multiply operation can be equivalently represented using one or more matrix-vector multiply operations (e.g., using transformed vectors and/or matrices) and vice versa.

The advantages of the disclosed techniques include but are not limited to increased shader performance during evaluation of MLPs for graphics elements of a scene.

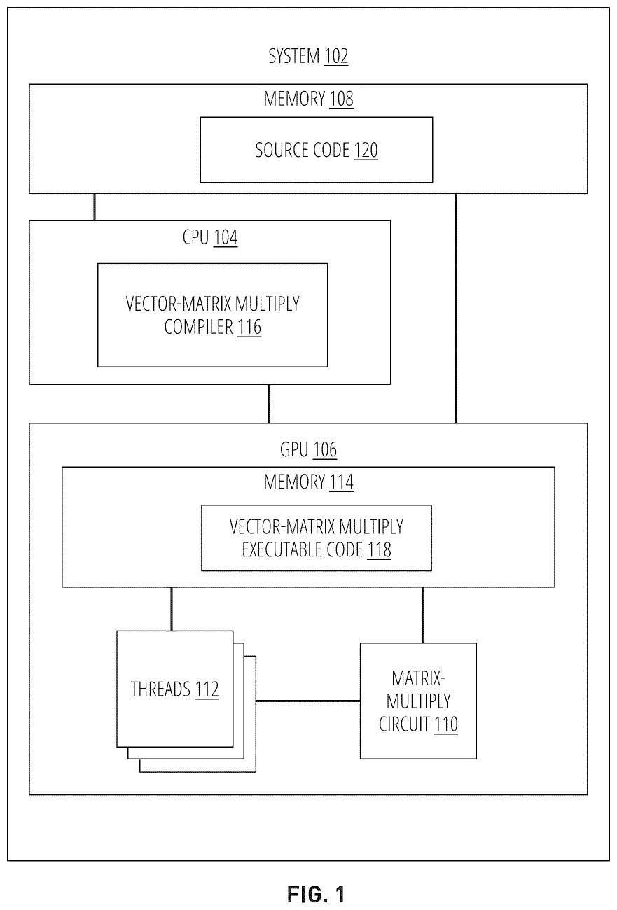

FIG. 1 is a block diagram of an example computer system 102 for efficient vector-matrix multiply operations across parallel processing unit threads, according to at least one embodiment. System 102 can be used to compile source code 120 (e.g., a shader program that evaluates a MLP on each thread) into an executable code to be executed by a parallel processing unit. System 102 can also execute the executable code (e.g., using GPU 106).

System 102 can include memory 108, CPU 104, and GPU 106. Memory 108 can be connected to CPU 104 and/or GPU 106. CPU 104 can also be connected to GPU 106.

Memory 108 can include one or more registers, one or more caches (e.g., L1 cache, L2 cache, etc.), and/or main memory (e.g., random-access memory (RAM), dynamic RAM (DRAM), static RAM (SRAM), synchronous DRAM (SDRAM), double data rate SDRAM (DDR SDRAM), etc.). Memory 108 can store source code 120, executable code (e.g., vector-matrix multiply executable code 118), graphics data (e.g., pixel values, textures, lighting information, etc.), MLP information (e.g., weight matrices, bias vectors, gradients, etc.), and/or the like.

CPU 104 can execute one or more processes based on corresponding instructions (e.g., from memory 108). CPU 104 can execute vector-matrix multiply compiler 116 to compile source code 120 into an executable code (e.g., vector-matrix multiply executable code 118). The executable code can be executed by a parallel processing unit (e.g., GPU 106) in a SIMT manner. In some embodiments, source code 120 is compiled by CPU 104 to generate an executable code, and the executable code is executed by a parallel processing unit separate from system 102. For example, a source code (e.g., source code 120) can be compiled to generate an executable code on a first device, and the executable code can be executed by a parallel processing unit of a second device.

Source code 120 can identify one or more vector-matrix multiply operations to be performed by a plurality of threads of a parallel processing unit. The vector of the vector-matrix multiply operation can be a vector representation of a graphics element (e.g., pixel, ray, vertex, etc.) being processed by the thread. The executable code produced by vector-matrix multiply compiler 116 can be configured to receive at runtime the vector representation of the graphics element being processed by the thread. The matrix of the vector-matrix operation can be a weight matrix corresponding to a layer of a MLP used to evaluate the graphics element. In some embodiments, the MLP may include multiple layers, which can be evaluated using multiple vector-matrix multiply operations utilizing more than one weight matrix (e.g., one weight matrix corresponding to each layer of the MLP). In some embodiments, source code 120 also identifies a bias vector that should be combined with (e.g., added to, subtracted from, etc.) the result of the vector-matrix multiply operation. The weight matrix and/or bias vector can be loaded from memory (e.g., memory 114) at runtime of the executable code. In some embodiments, one or more matrices loaded from memory are transposed during loading. In some embodiments, the weight matrix can be stored in an optimized format such that cache hits are increased when threads load the weight matrix from memory. In some embodiments, the weight matrix can be converted to the optimized format by a first processor (e.g., a CPU) before the weight matrix is stored in memory of a parallel processing unit (e.g., a GPU).

More specifically, vector-matrix multiply compiler 116 can parse source code 120 and identify regions of interest (e.g., regions with SIMT vector-matrix multiply instructions, which may be part of an application programming interface (API) and/or software development kit (SDK) related to the present disclosure). Vector-matrix multiply compiler 116 can then build a fast path that will be executed when all threads are active and a slow path that will be used when not all threads are active. Vector-matrix multiply compiler 116 can include instructions in the executable code to shuffle the input matrices (e.g., transform them from an input format to a matrix-multiply format) identified by source code 120 and to unshuffle (e.g., transform from the matrix-multiply format to the input format) the values resulting from the matrix multiply operation(s).

Vector-matrix multiply compiler 116 can include instructions in the executable code to rewrite one or more activation functions included in source code 120 to operate on shuffled data. For example, source code 120 can include SIMT vector-matrix multiply instructions and one or more activation functions to evaluate the output of each layer of the MLP. Vector-matrix multiply compiler 116 can shuffle the input matrices from an input format to a matrix-multiply format, causing the output of the matrix-vector/matrix-matrix multiply operation to be in matrix-multiply format. Vector-matrix multiply compiler 116 can translate the activation function from source code 120 into one or more executable code instructions that produce the desired result on the shuffled data (e.g., the matrix-vector/matrix-matrix multiply operation output in the matrix-multiply format).

Vector-matrix multiply compiler 116 can remove any unshuffle instructions followed by shuffle instructions to keep the matrix-multiply output in the matrix-multiply format until the final layer of the MLP has been evaluated. Vector-matrix multiply compiler 116 can then add instructions that perform matrix-matrix multiply operations for each unique weight matrix included in a thread. Vector-matrix multiply compiler 116 can generate vector-matrix multiply executable code 118 based on the provided source code.

In some embodiments, vector-matrix multiply compiler 116 can build an alternative path that can be executed when not all threads are active. For example, one or more threads can be deactivated based on control flow divergence at runtime and/or weight matrix nonuniformity. A “set active mask” (SAM) operation and/or a “restore active mask” (RAM) operation can be performed to indicate to the parallel processing unit which threads are active and/or inactive.

In some embodiments, vector-matrix multiply compiler 116 can include instructions in the executable code that perform matrix math operations without using specialized matrix-multiply circuits. For example, if there is sufficient control flow divergence and/or weight matrix nonuniformity, it may be advantageous to evaluate the matrix operations of each thread not using the dedicated matrix-multiply circuits. In some embodiments, vector-matrix multiply compiler 116 does not use SIMT for one or more graphic tasks. For example, in some embodiments, vector-matrix multiply compiler 116 may not use SIMT instructions when compiling source code related to ray tracing graphics processing tasks.

GPU 106 can include memory 114 and can be coupled (e.g., communicatively coupled) to CPU 104 and/or memory 108. Memory 114 can include one or more registers, one or more caches (e.g., L1 cache, L2 cache, etc.), and/or main memory (e.g., random-access memory (RAM), dynamic RAM (DRAM), static RAM (SRAM), synchronous DRAM (SDRAM), double data rate SDRAM (DDR SDRAM), etc.). Memory 114 can store graphics data (e.g., pixels, vertices, textures, lighting information, etc.), MLP data (e.g., weight matrices, bias vectors, gradients, etc.), vector-matrix multiply executable code 118, and/or the like. GPU 106 can include one or more threads 112 for parallel execution of an executable code and matrix-multiply circuit 110 for efficient execution of matrix-matrix multiply operations. In some embodiments, matrix-multiply circuit 110 is a Tensor Core. GPU 106 can execute vector-matrix multiply executable code 118 from memory 114.

Vector-matrix multiply executable code 118 can include instructions that cause the parallel processing unit (e.g., GPU 106) to combine vectors from at least a subset of the one or more vector-matrix multiply operations into an input matrix. Vector-matrix multiply executable code 118 can also include instructions that cause the parallel processing unit to multiply the input matrix by a first matrix (e.g., by a weight matrix corresponding to a layer of a MLP) using a matrix-multiply circuit (e.g., matrix-multiply circuit 110, a Tensor Core, etc.) to obtain a result matrix. Vector-matrix multiply executable codes 118 can also include instructions that cause the parallel processing unit to separate the result matrix into a plurality of result values, each result value of the plurality of result values corresponding to a thread of the plurality of threads.

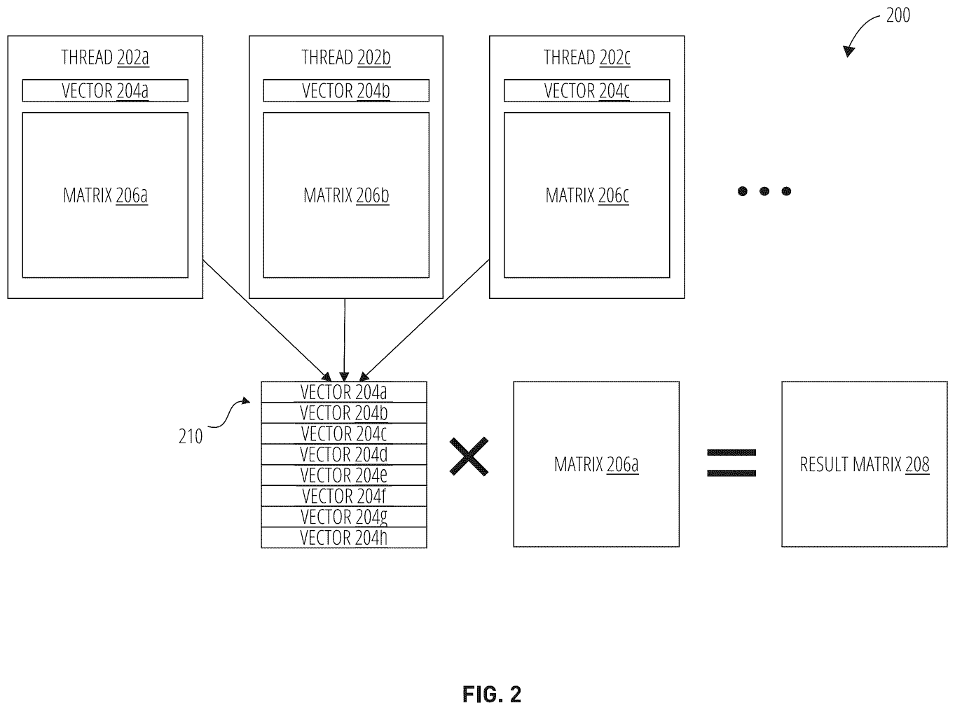

FIG. 2 is a block diagram of an example data flow 200 for efficient vector-matrix multiply operations across parallel processing unit threads, according to at least one embodiment. A plurality of threads (e.g., thread 202a, thread 202b, thread 202c, etc.) can be executing simultaneously. Each thread can include a vector (e.g., vector 204a, vector 204b, vector 204c, etc.) and a matrix (e.g., matrix 206a, matrix 206b, matrix 206c, etc.). The vector of each thread can correspond to a representation of the graphics element being processed by the thread. The matrix of each thread can correspond to the weights of connections between neurons of two adjacent layers of the MLP. In some embodiments, a thread includes more than one matrix, each matrix corresponding to weights of connections between adjacent layers of the MLP.

The vectors of each thread can be combined to make input matrix 210. For example, input matrix 210 can include vector 204a, vector 204b, vector 204c, vector 204d, vector 204c, vector 204f, vector 204g, and vector 204h. In some embodiments, one or more vectors of input matrix 210 can include padding values. For example, if a matrix-multiply circuit of the parallel processing unit executing the threads is configured to receive a matrix with 8 rows but only 5 threads are active, input matrix 210 can include 3 rows of padding to satisfy the requirements of the matrix-multiply circuit. In some embodiments, if there are more active threads than the matrix-multiply circuit can handle, more than one input matrix 210 can be created and provided to the matrix-multiply circuit in sequence. In some embodiments, if only one thread is active, input matrix 210 can include the vector of the active thread and padding to satisfy the requirements of the matrix-multiply circuit.

Input matrix 210 and matrix 206a can be multiplied (e.g., matrix product) via a matrix-multiply circuit (e.g., matrix-multiply circuit 110 of FIG. 1) to obtain result matrix 208. If the matrix of each thread is the same, result matrix 208 can include a result value for each thread. If one or more of matrices 206a-206c are different, input matrix 210 can be multiplied by each unique matrix 206a-206c, resulting in more than one result matrix 208. Result values from each result matrix 208 can be selected so each thread has its corresponding value.

For example, given 3 threads 202a, 202b, and 202c, thread 202a may have a first weight matrix (e.g., matrix 206a) and threads 202b and 202c may have the same weight matrix (e.g., matrix 206b may be the same as matrix 206c). Input matrix 210 may be multiplied by the first weight matrix to obtain a first result matrix. Input matrix 210 may also be multiplied by the second weight matrix to obtain a second result matrix. The result value for thread 202a may come from the first result matrix, and the result values for thread 202b and thread 202c may come from the second result matrix. In some embodiments, the result value from the first result matrix for thread 202a and the result values from the second result matrix for thread 202b and thread 202c may be combined into a single matrix.

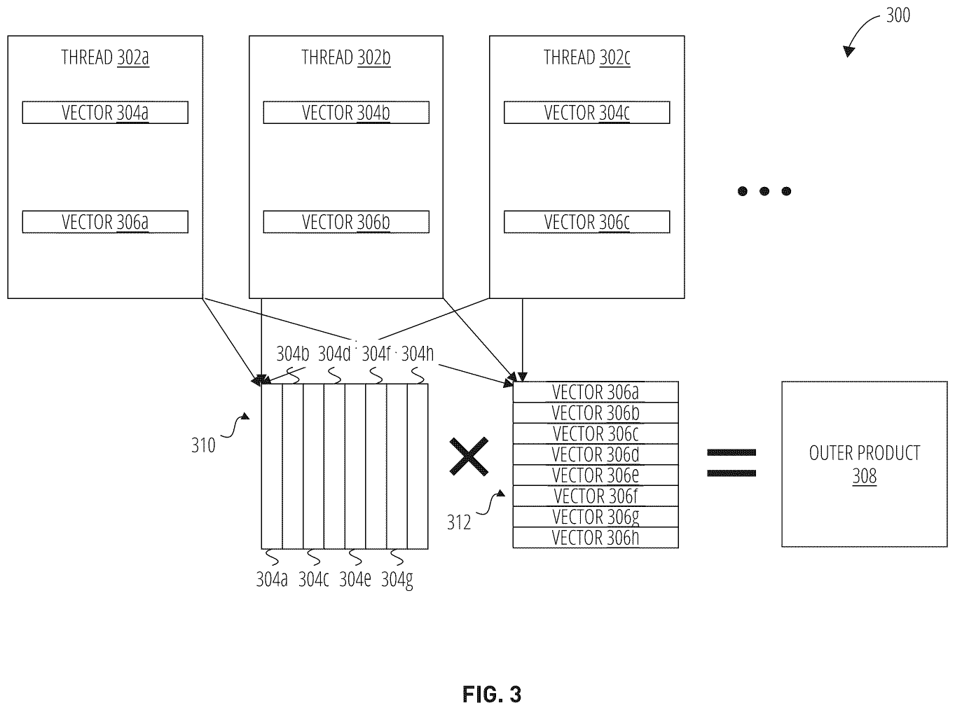

FIG. 3 is a block diagram of an example data flow 300 for efficient vector-vector multiply operations across parallel processing unit threads, according to at least one embodiment. In some embodiments, it can be advantageous to perform vector-vector multiply operations in a SIMT manner, such as, for example, during training of a MLP. A plurality of threads (e.g., thread 302a, thread 302b, thread 302c, etc.) can be executing simultaneously. Each thread can include a first vector (e.g., vector 304a, vector 304b, vector 304c, etc.) and a second vector (e.g., vector 306a, vector 306b, vector 306c, etc.). The first vector of each thread can correspond to an error vector (e.g., loss vector) indicating an error between the generated output of the MLP and the target output. The second vector of each thread can correspond to the output of a particular layer of the MLP.

The first vectors of each thread can be combined to make first matrix operand 310. For example, first matrix operand 310 can include vector 304a, vector 304b, vector 304c, vector 304d, vector 304c, vector 304c, vector 304f, vector 304g, and vector 304h. The second vectors of each thread can be combined to make second matrix operand 312. For example, second matrix operand 312 can include vector 306a, vector 306b, vector 306c, vector 306d, vector 306c, vector 306f, vector 306g, and vector 306h.

First matrix operand 310 and second matrix operand 312 can be multiplied (e.g., matrix product) via a matrix-multiply circuit (e.g., matrix-multiply circuit 110 of FIG. 1) to obtain the outer product of vector 304a and vector 306a, the outer product of vector 304b and vector 306b, etc., included in outer product 308. In some embodiments, outer product 308 represents the sum of K outer product operations, where K is equal to the number of threads participating in the operation. For example, first matrix operand 310 can be an N×K matrix, where N is the number of values in each of the vectors from the K threads and each vector is a column of the matrix, and second matrix operand 312 can be a K×N matrix, where each vector is a row of the matrix. Multiplying first matrix operand 310 and second matrix operand 312 can result in an N×N matrix output (e.g., outer product 308).

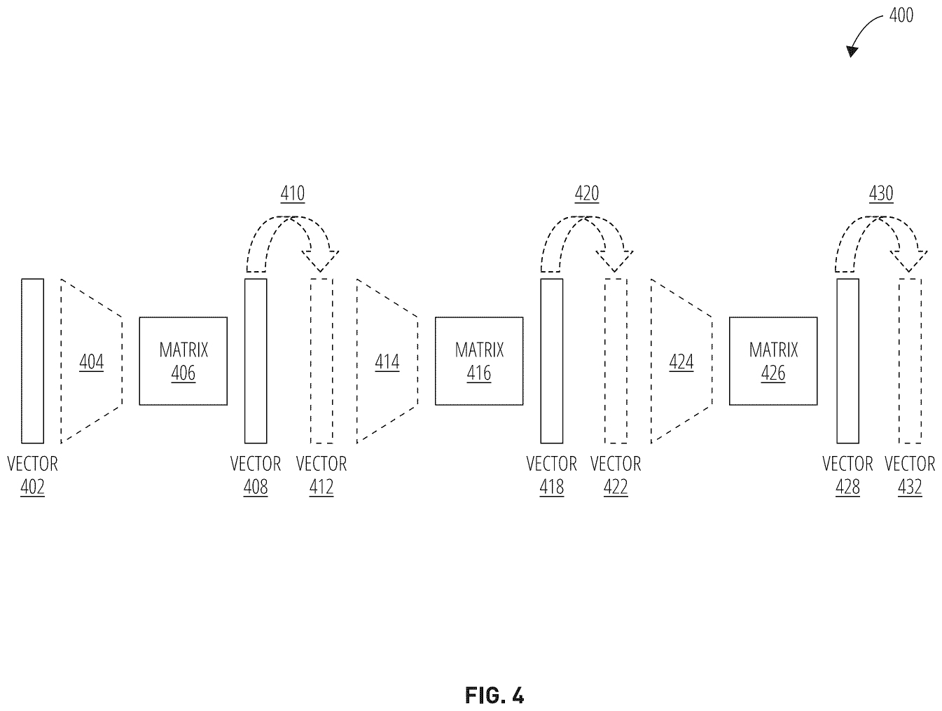

FIG. 4 is a block diagram of an example data flow 400 for efficient vector-matrix multiply operations, according to at least one embodiment. Data flow 400 can represent the operations that are being applied to an individual vector during an efficient matrix-matrix multiply operation. In other words, the vectors of FIG. 4 could be replaced by matrices (e.g., a collection of vectors). In some embodiments (e.g., ignoring elements with dashed lines), vector 402 can be multiplied by matrix 406 to obtain vector 408. That operation can represent a first layer of the MLP of a thread. For example, vector 402 can be a vector representation of the graphics element being processed by the thread and can be provided as input to the MLP of the thread. Vector 408 can be an intermediate vector, the output of the first vector-matrix operation of the MLP. Vector 408 can be multiplied by matrix 416 to obtain vector 418, another intermediate vector. That operation can represent a second layer of the MLP of the thread. Vector 418 can be multiplied by matrix 426 to obtain vector 428, the output of the final layer of the MLP. In some embodiments, the values of vector 428 are combined (e.g., summed) to obtain a single, scalar value. In some embodiments, before multiplying the intermediate vector with the next matrix, an activation function is applied to the intermediate vector. The activation function can be one of a rectified linear unit (ReLu), sigmoid, hyperbolic tangent (Tanh), leaky RcLu, softmax, and/or another non-linear function.

In some embodiments, the input vector (e.g., vector 402) can be shuffled from an input format to a matrix-multiply format. When a vector (or matrix) in the matrix-multiply format is multiplied by another matrix, the resulting value is also in the matrix-multiply format. As such, during compilation of the source code, the compiler can modify the instructions corresponding to the activation functions in the source code (which can be written with the assumption that the data is in the input format) to equivalent instructions that apply the activation function to the data in the matrix-multiply format. If the input vector (e.g., vector 402) was shuffled, the output vector (e.g., vector 428) can be unshuffled to return the data to the input format.

In some embodiments, the values of the input vector (e.g., vector 402) have a first numeric format and the values of the matrices (e.g., matrix 406, matrix 416, matrix 426, etc.) have a second numeric format different than the first numeric format. The compiler can include instructions in the executable code that cause the parallel processing unit executing the code to interpret the values of the input vector according to the second numeric format. The parallel processing unit can apply implicit conversion 404 to convert vector 402 to a numeric format compatible with that of matrix 406 for performing the matrix-multiplication operation. The resulting vector (e.g., vector 408) can be of the first numeric format. Vector 408 can go through implicit conversion 414 (e.g., following application of the activation function) before being multiplied by matrix 416. Similarly, vector 418 can go through implicit conversion 424 before being multiplied by matrix 426. The resulting vector (e.g., vector 428) can be of the same numeric format as the input vector (e.g., vector 402).

For example, the input vector can include FP16 values, and each matrix can include FP8 values. Implicit conversion 404 (and implicit conversion 414 and implicit conversion 424) can convert the FP16 values to FP8 values for multiplication, and the resulting values can be in FP16 again. The output vector can include FP16 values, matching the numeric format of the input values.

In some embodiments, the intermediate vectors can be normalized (e.g., normalization 410, normalization 420, normalization 430) before being implicitly converted and/or multiplied by the next matrix. For example, input vector can include 32-bit floating point values (FP32) and the matrices can include 8-bit integer values (INT8). Vector 402 can go through implicit conversion 404 to convert the FP32 values to INT8 values before being multiplied by matrix 406. The intermediate vector result (e.g., vector 408) can have 32-bit integer values (INT32). Normalization 410 can convert the intermediate vector values back to the input numeric format (e.g., FP32). Normalization 410 can include scaling the values, normalizing the values, converting them from a first numeric format to a second numeric format, and/or other operations. After normalization 410 converts vector 408 into vector 412, the activation function can be applied to vector 412. The output of the activation function can go through implicit conversion 414 and be multiplied by matrix 416, resulting in vector 418. Vector 418 can be converted to vector 422 via normalization 420. The output of the activation function based on vector 422 can go through implicit conversion 424 and be multiplied by matrix 426 to obtain vector 428. Vector 428 can be converted to vector 432 via normalization 430. In some embodiments, normalization 410 applies different operations than normalization 420 and/or normalization 430. In some embodiments, the normalization operations are the same.

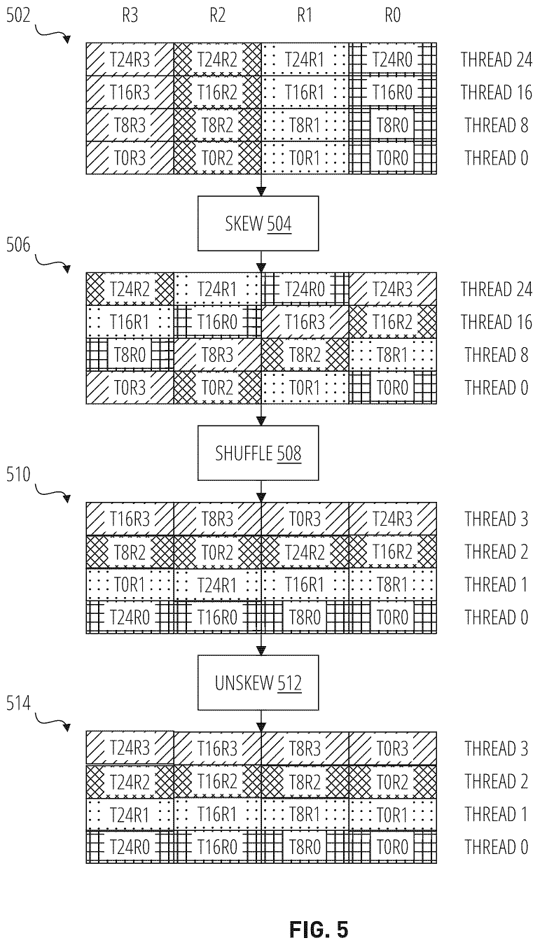

FIG. 5 is a block diagram of an example shuffled memory layout 514 for efficient vector-matrix multiply operations across parallel processing unit threads, according to at least one embodiment. Memory layout 502 depicts a subset of values stored in memory (e.g., memory 108 of FIG. 1, memory 114 of FIG. 1, etc.). In some embodiments, the values stored in memory correspond to input vector values. Memory layout 502 depicts data for thread 0, thread 8, thread 16, and thread 24 out of, for example, 32 threads. The data can be stored in different registers of the memory (e.g., register 0 (R0), register 1 (R1), register 2 (R2), and register 3 (R3)). The layout depicted in memory layout 502 can correspond to the input format discussed herein, and the layout depicted in memory layout 514 can correspond to the matrix-multiply format discussed herein. Converting between the input layout and the matrix-multiply layout can require shuffling values between threads. These shuffles can naively have an access pattern that requires partially utilized shuffle instructions, where each thread does extra shuffles but only some shuffle results are used. In some embodiments, the vectors can be skewed by moving values around within a thread before shuffling, resulting in shuffles that are fully utilized.

The following provides one example of skewing thread values, shuffling the values, and unskewing the values to convert from the input format to the matrix-multiply format. It should be understood that other operations can be performed and/or some operations shown can not be performed to convert from the input format to the matrix-multiply format.

Memory layout 502 can be skewed (e.g., by skew 504) to obtain memory layout 506. To skew memory layout 502, the values stored in thread 8 can be shifted by one register to the right, with the values looping around from R0 to R3. The values stored in thread 16 can be shifted by two registers to the right, with the values looping around from R0 to R3. The values stored in thread 24 can be shifted by three registers to the right, with the values looping around from R0 to R3.

Then, memory layout 506 can be shuffled (e.g., by shuffle 508) to obtain memory layout 510. To shuffle memory layout 506, one or more values can be swapped between registers and/or threads. In some embodiments, values are moved from high registers (e.g., 8, 16, and 24) to lower registers (e.g., 1, 2, and 3). For example, the value of thread 0 and R1 (T0R1) can be swapped with the value of thread 8 and R3 (T8R0). The value of thread 0 and R2 (T0R2) can be swapped with the value of thread 16 and R2 (T16R0). The value of thread 0 and R3 (T0R3) can be swapped with the value of thread 24 and R1 (T24R0). The value of thread 8 and R1 (T8R2) can be swapped with the value of thread 16 and R3 (T16R1). The value of thread 8 and R2 (T8R3) can be swapped with the value of thread 24 and R2 (T24R1). The value of thread 16 and R1 (T16R3) can be swapped with the value of thread 24 and R3 (T24R2). Similar swaps can be performed for other groups of threads (e.g., for the group of threads 1, 9, 17, and 25; for the group of threads 2, 10, 18, and 26; etc.).

Then, memory layout 510 can be converted to the final matrix-multiply format (e.g., memory layout 514) by unskewing (e.g., by unskew 512) the values stored in the registers. In some embodiments, unskew 512 can perform an inverse operation as skew 504. For example, unskew 512 can shift the values stored in thread 1 (those values previously stored in thread 8) one register to the left, with the values looping around from R3 to R0. The values stored in thread 2 (those values previously stored in thread 16) can be shifted two registers to the left, with the values looping around from R3 to R0. The values stored in thread 3 (those values previously stored in thread 24) can be shifted three registers to the left, with the values looping around from R3 to R0.

By skewing and shuffling the values stored in memory, memory access can be optimized across threads during execution of parallel vector-matrix multiply operations.

In some embodiments, the matrix-multiply format can vary based on the numeric format (e.g., bit length, etc.) of the values being stored. For example, the order of columns for INT8 values can be different than the order of columns for INT32 values. In some embodiments, it can be advantageous to store two copies of the same data in memory. For example, a first copy of the data can be shuffled and stored in the INT8 column format, and a second copy can be shuffled and stored in the INT32 column format (regardless of the actual bit lengths of the values being stored). The first copy of the data can be used on a first layer of a MLP, and the second copy of the data can be used on one or more other layers of the MLP.

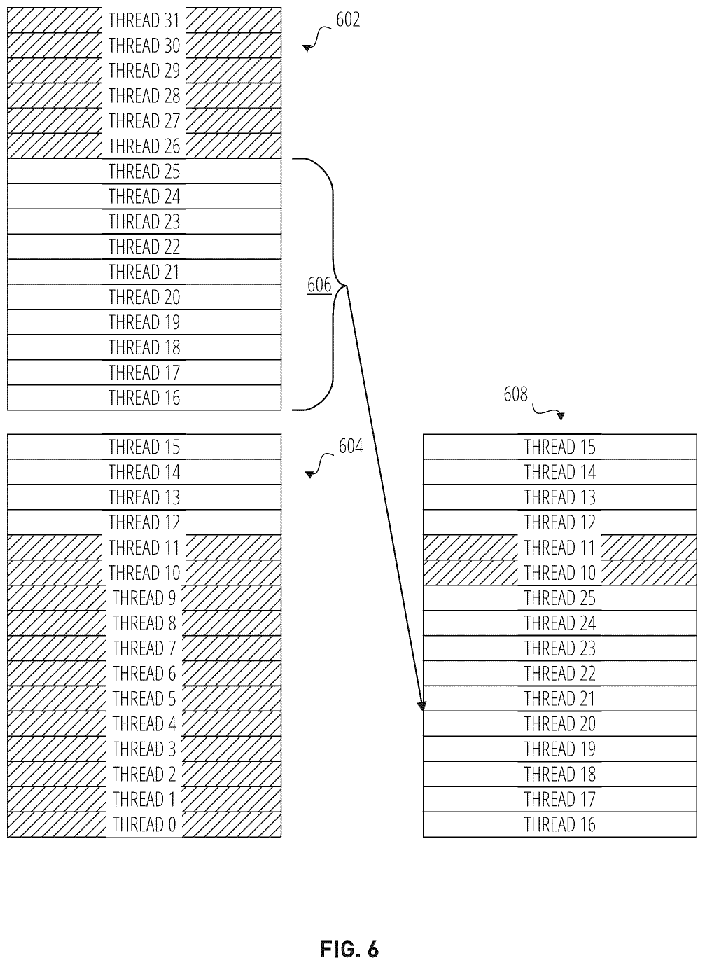

FIG. 6 is a block diagram of an example thread manipulation for efficient vector-matrix multiply operations across parallel processing unit threads, according to at least one embodiment. A parallel processing unit can include one or more threads. In some embodiments, the threads can be divided into one or more subsets. As described above, during execution of the executable code, the parallel processing unit can deactivate one or more threads (e.g., due to control flow divergence, matrix nonuniformity, etc.). Because some instructions (e.g., in the executable code) can operate over a subset of the threads, if a subset of the threads are deactivated, it can be advantageous to execute fewer instructions, only targeting the active threads. For example, FIG. 6 depicts a parallel processing unit with 32 threads total. Some instructions (e.g., matrix-multiply operations) can operate on 16 threads at a time. Thread subset 602 includes 16 threads, 6 of which (threads 26-31) are inactive, and 10 of which are active (threads 16-25) (e.g., active threads 606). Thread subset 604 includes 16 threads, 12 of which are inactive (threads 0-11) and 4 of which are active (threads 12-15). Because active threads 606 of thread subset 602 can “fit” within the inactive threads of thread subset 604, the threads (or the work being performed by those threads) can be moved to create combined threads 608. Now, one set of instructions can be applied to combined threads 608 instead of applying a first instruction to thread subset 602 and a second command to thread subset 604.

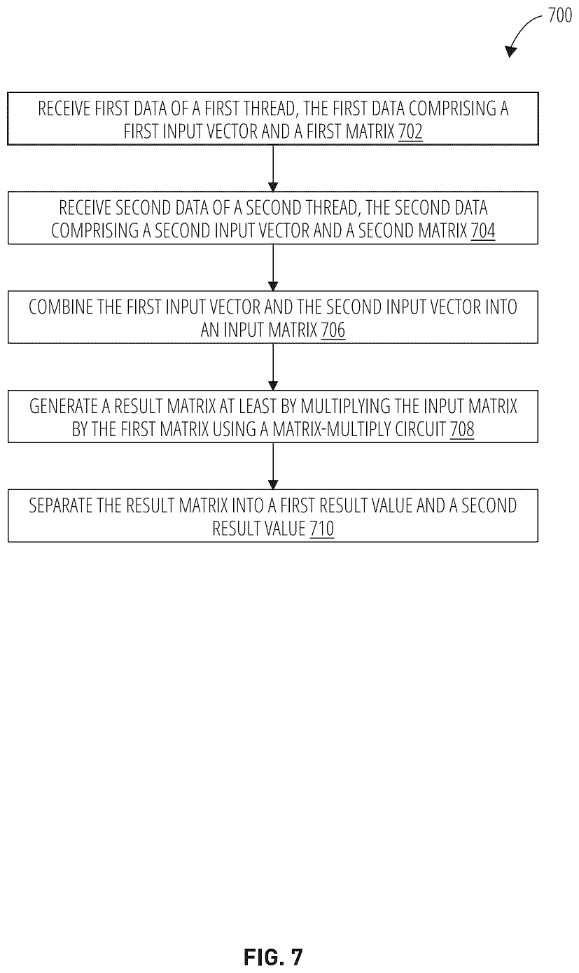

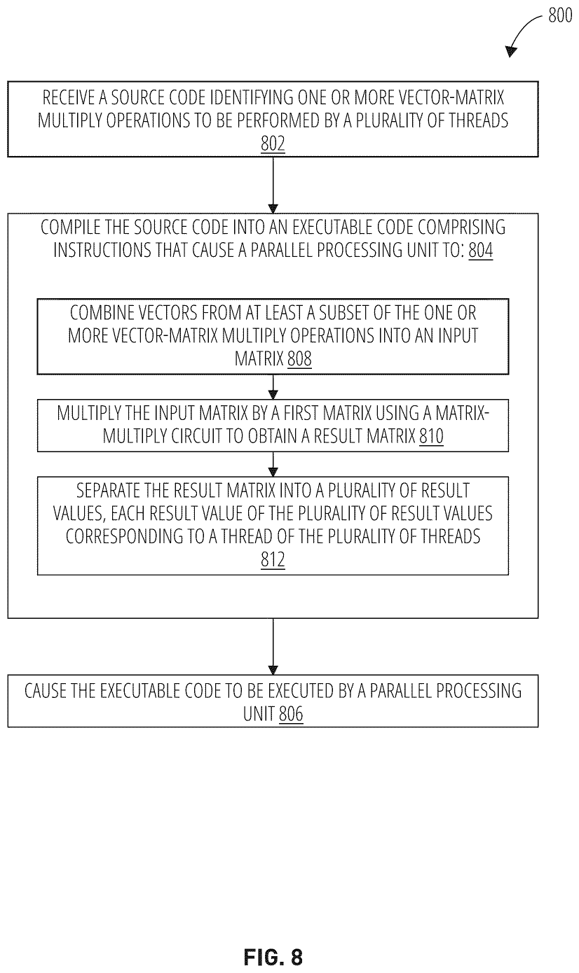

FIG. 7 is a flow diagram of an example method 700 for efficient vector-matrix multiply operations across parallel processing unit threads, according to at least one embodiment. FIG. 8 is a flow diagram of an example method 800 for compiling executable code for efficient vector-matrix multiply operations across parallel processing unit threads, according to at least one embodiment.

Methods 700 and/or 800 can be performed using one or more processing units (e.g., CPUs, GPUs, accelerators, physics processing units (PPUs), data processing units (DPUs), etc.), which may include (or communicate with) one or more memory devices. In at least one embodiment, methods 700 and/or 800 can be performed using a processing device or processing devices. In at least one embodiment, method 700 can be performed using processing units of GPU 106 of FIG. 1. In at least one embodiment, method 800 can be performed by system 102 of FIG. 1. In at least one embodiment, processing units performing any of methods 700 and/or 800 can be executing instructions stored on a non-transient computer readable storage media. In at least one embodiment, any of methods 700 and/or 800 can be performed using multiple processing threads (e.g., CPU threads and/or GPU threads), individual threads executing one or more individual functions, routines, subroutines, or operations of the method. In at least one embodiment, processing threads implementing any of methods 700 and/or 800 can be synchronized (e.g., using semaphores, critical sections, and/or other thread synchronization mechanisms). Alternatively, processing threads implementing any of methods 700 and/or 800 can be executed asynchronously with respect to each other. Various operations of methods 700 and/or 800 can be performed in a different order compared with the order shown in FIG. 7 and/or FIG. 8. Some operations of any of methods 700 and/or 800 can be performed concurrently with other operations. In at least one embodiment, one or more operations shown in FIG. 7 and/or FIG. 8 may not always be performed.

FIG. 7 is a flow diagram of an example method 700 for efficient vector-matrix multiply operations across parallel processing unit threads, according to at least one embodiment. In some embodiments, method 700 is performed by a parallel processing unit. At block 702, processing units executing method 700 can receive first data of a first thread, the first data comprising a first input vector (e.g., a vector representation of a first graphics element) and a first matrix (e.g., a weight matrix corresponding to a layer of a MLP). At block 704, processing units can receive second data of a second thread, the second data comprising a second input vector (e.g., a vector representation of a second graphics element) and a second matrix (e.g., a weight matrix corresponding to a layer of a MLP). At block 706, processing units can combine the first input vector and the second input vector into an input matrix. At block 708, processing units can generate a result matrix at least by multiplying the input matrix by the first matrix using a matrix-multiply circuit. At block 710, processing units can separate the result matrix into a first result value and a second result value, the first result value corresponding to the first thread and the second result value corresponding to the second thread.

In some embodiments, the first matrix and the second matrix are the same. For example, the first matrix and the second matrix could correspond to the same weight matrix of a MLP. In some embodiments, the first matrix and the second matrix are different. Generating the result matrix can further include multiplying the input matrix by the second matrix using the matrix-multiply circuit to obtain a third matrix, wherein the result matrix comprises at least part of the third matrix. For example, if there is weight matrix nonuniformity between two threads, a first matrix-multiply operation can be performed using the input matrix and the weight matrix of the first thread to obtain a first result value and a second matrix-multiply operation can be performed using the input matrix and the weight matrix of the second thread to obtain a second result value. In some embodiments, the first result value and the second result value are combined into a single result matrix.

In some embodiments, the first data of the first thread further comprises a third matrix. For example, the third matrix can correspond to a weight matrix for a second layer of the MLP associated with the thread. In some embodiments, multiplying the input matrix by the first matrix using the matrix-multiply circuit generates an intermediate matrix. Generating the result matrix can further include multiplying the intermediate matrix by the third matrix using the matrix-multiply circuit to obtain a fourth matrix. The result matrix can include at least part of the fourth matrix.

In some embodiments, generating the result matrix further includes, prior to the multiplying the input matrix by the first matrix, transforming the input matrix from an input format to a matrix-multiply format. For example, the input matrix can be skewed, shuffled, and unskewed, as discussed above, to transform from the input format to the matrix-multiply format. Generating the result matrix can further include transforming the result matrix from the matrix-multiply format to the input format.

In some embodiments, generating the result matrix can include combining (e.g., adding, subtracting, etc.) the result matrix with a third matrix. The third matrix can be a bias matrix comprising bias vectors from layers of the MLP being evaluated. In some embodiments, the input matrix comprises the first input vector, the second input vector, and one or more padding values. For example, the input matrix can be padded to match the required dimensions of the matrix-multiply circuit. In some embodiments, first values of the first input vector have a first bit length and second values of the first matrix have a second bit length. The first bit length and the second bit length can be different. The parallel processing unit can perform an implicit conversion, as discussed above, to calculate a matrix-multiply result despite the different bit lengths.

FIG. 8 is a flow diagram of an example method 800 for compiling executable code for efficient vector-matrix multiply operations across parallel processing unit threads, according to at least one embodiment. At block 802, processing units performing method 800 can receive a source code identifying one or more vector-matrix multiply operations to be performed by a plurality of threads. At block 804, processing units can compile the source code into an executable code comprising instructions that cause a parallel processing unit to: combine vectors from at least a subset of the one or more vector-matrix multiply operations into an input matrix (block 808), multiply the input matrix by a first matrix using a matrix-multiply circuit to obtain a result matrix (block 810), and separate the result matrix into a plurality of result values, each result value of the plurality of result values corresponding to a thread of the plurality of threads (block 812). At block 806, processing units executing method 800 can cause the executable code to be executed by a parallel processing unit.

In some embodiments, the instructions further cause the parallel processing unit to, prior to multiplying the input matrix by the first matrix, shuffle the input matrix from an input format to a matrix-multiply format. The instructions can further cause the parallel processing unit to, prior to separating the result matrix into the plurality of result values, shuffle the result matrix from the matrix-multiply format to the input format.

In some embodiments, multiplying the input matrix by the first matrix using the matrix-multiply circuit includes multiplying the input matrix by the first matrix using the matrix-multiply circuit to obtain an intermediate matrix and multiplying the intermediate matrix by a second matrix using the matrix-multiply circuit to obtain the result matrix. The second matrix can correspond to at least a second vector-matrix multiply operation of the one or more vector-matrix multiply operations.

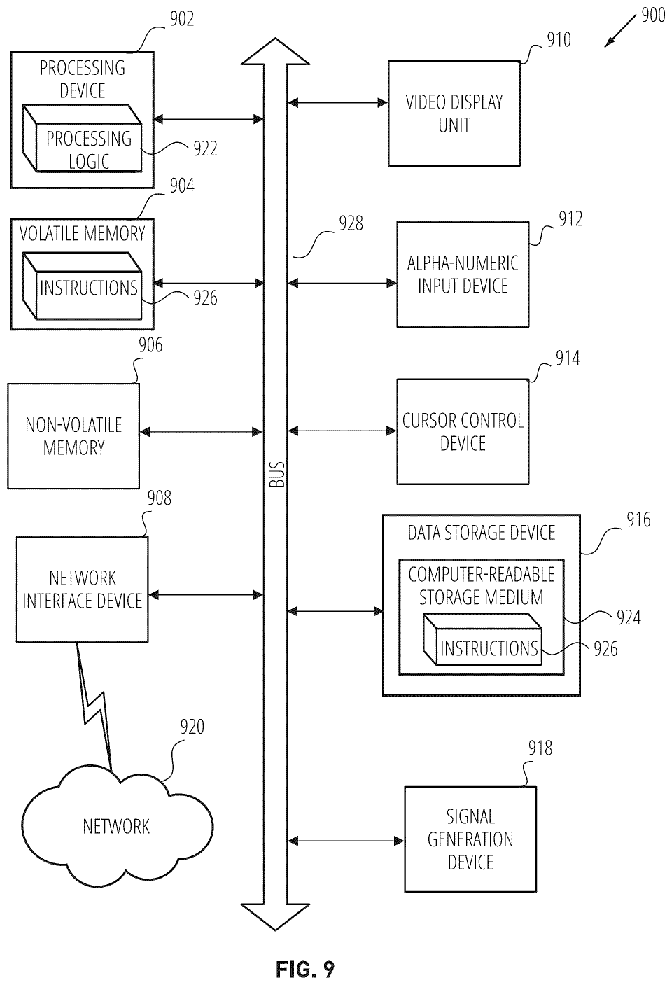

FIG. 9 is a block diagram illustrating an exemplary computer system, in accordance with at least one embodiment of the present disclosure. The computer system 900 can correspond to system 102, described with respect to FIG. 1. Computer system 900 can operate in the capacity of a server or an endpoint machine in an endpoint-server network environment, or as a peer machine in a peer-to-peer (or distributed) network environment. The machine can be a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The example computer system 900 includes a processing device (processor) 902, a main memory 904 (e.g., read-only memory (ROM), flash memory, dynamic random access memory (DRAM) such as synchronous DRAM (SDRAM), double data rate (DDR SDRAM), or DRAM (RDRAM), etc.), a static memory 906 (e.g., flash memory, static random access memory (SRAM), etc.), and a data storage device 916, which communicate with each other via a bus 928.

Processor (processing device) 902 represents one or more general-purpose processing devices such as a microprocessor, central processing unit, graphics processing unit, or the like, and may include processing logic 922. More particularly, the processor 902 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processor 902 can also be one or more special-purpose processing devices such as an application specific integrated circuit (ASIC), a field programmable gate array (FPGA), a digital signal processor (DSP), network processor, or the like. The processor 902 is configured to execute instructions 926 (e.g., for generating threat indicator alerts) for performing the operations discussed herein.

The computer system 900 can further include a network interface device 908. The computer system 900 also can include a video display unit 910 (e.g., a liquid crystal display (LCD) or a cathode ray tube (CRT)), an input device 912 (e.g., a keyboard, and alphanumeric keyboard, a motion sensing input device, touch screen), a cursor control device 914 (e.g., a mouse), and a signal generation device 918 (e.g., a speaker). In some embodiments, computer system 900 may not include video display unit 910, input device 912, and/or cursor control device 914 (e.g., in a headless configuration).

The data storage device 916 can include a non-transitory machine-readable storage medium 924 (also computer-readable storage medium) on which is stored one or more sets of instructions 926 (e.g., for efficient vector-matrix multiply operations across parallel processing unit threads and/or for compiling source code to generate an executable code for efficient vector-matrix multiply operations across parallel processing unit threads) embodying any one or more of the methodologies or functions described herein. The instructions 926 can also reside, completely or at least partially, within the main memory 904 and/or within the processor 902 during execution thereof by the computer system 900, the main memory 904 and the processor 902 also constituting machine-readable storage media. The instructions can further be transmitted or received over a network 920 via the network interface device 908.

In one implementation, the instructions 926 include instructions for efficient vector-matrix multiply operations across parallel processing unit threads and/or for compiling source code to generate an executable code for efficient vector-matrix multiply operations across parallel processing unit threads. While the computer-readable storage medium 924 (machine-readable storage medium) is shown in an exemplary implementation to be a single medium, the terms “computer-readable storage medium” and “machine-readable storage medium” should be taken to include a single medium or multiple media (e.g., a centralized or distributed database, and/or associated caches and servers) that store the one or more sets of instructions. The terms “computer-readable storage medium” and “machine-readable storage medium” shall also be taken to include any medium that is capable of storing, encoding or carrying a set of instructions for execution by the machine and that cause the machine to perform any one or more of the methodologies of the present disclosure. The terms “computer-readable storage medium” and “machine-readable storage medium” shall accordingly be taken to include, but not be limited to, solid-state memories, optical media, and magnetic media.

### Inference and Training Logic

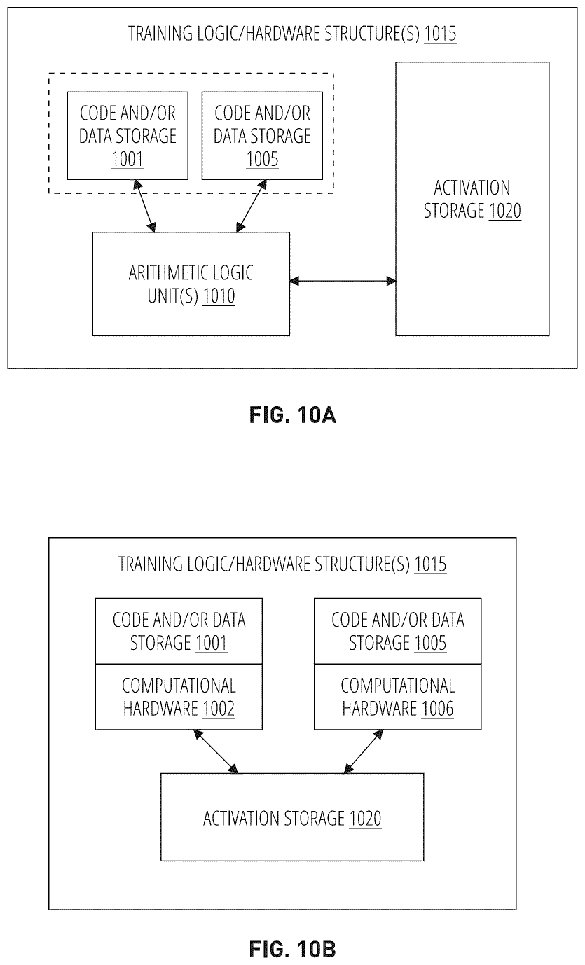

FIG. 10A illustrates inference and/or training logic 1015 used to perform inferencing and/or training operations associated with one or more embodiments.

In at least one embodiment, inference and/or training logic 1015 may include, without limitation, code and/or data storage 1001 to store forward and/or output weight and/or input/output data, and/or other parameters to configure neurons or layers of a neural network trained and/or used for inferencing in aspects of one or more embodiments. In at least one embodiment, training logic 1015 may include (or be coupled to code and/or data storage 1001 that stores) graph code or other software to control timing and/or order, in which weight and/or other parameter information is to be loaded to configure processing units, including logic units, integer and/or floating point units (collectively, arithmetic logic units (ALUs) or simply circuits). In at least one embodiment, code, such as graph code, loads weight or other parameter information into processor ALUs based on an architecture of a neural network to which such code corresponds. In at least one embodiment, code and/or data storage 1001 stores weight parameters and/or input/output data of each layer of a neural network trained or used in conjunction with one or more embodiments during forward propagation of input/output data and/or weight parameters during training and/or inferencing using aspects of one or more embodiments. In at least one embodiment, any portion of code and/or data storage 1001 may be included with other on-chip or off-chip data storage, including a processor's L1, L2, or L3 cache or system memory.

In at least one embodiment, any portion of code and/or data storage 1001 may be internal or external to one or more processors or other hardware logic devices or circuits. In at least one embodiment, code and/or data storage 1001 may be cache memory, dynamic randomly addressable memory (“DRAM”), static randomly addressable memory (“SRAM”), non-volatile memory (e.g., flash memory), or other storage. In at least one embodiment, a choice of whether code and/or data storage 1001 is internal or external to a processor, for example, or comprising DRAM, SRAM, flash or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 1015 may include, without limitation, a code and/or data storage 1005 to store backward and/or output weight and/or input/output data corresponding to neurons or layers of a neural network trained and/or used for inferencing in aspects of one or more embodiments. In at least one embodiment, code and/or data storage 1005 stores weight parameters and/or input/output data of each layer of a neural network trained or used in conjunction with one or more embodiments during backward propagation of input/output data and/or weight parameters during training and/or inferencing using aspects of one or more embodiments. In at least one embodiment, training logic 1015 may include (or be coupled to code and/or data storage 1005 that stores) graph code or other software to control timing and/or order, in which weight and/or other parameter information is to be loaded to configure processing units, including logic units, integer and/or floating point units (collectively, arithmetic logic units (ALUs)).

In at least one embodiment, code, such as graph code, causes the loading of weight or other parameter information into processor ALUs based on an architecture of a neural network to which such code corresponds. In at least one embodiment, any portion of code and/or data storage 1005 may be included with other on-chip or off-chip data storage, including a processor's L1, L2, or L3 cache or system memory. In at least one embodiment, any portion of code and/or data storage 1005 may be internal or external to one or more processors or other hardware logic devices or circuits. In at least one embodiment, code and/or data storage 1005 may be cache memory, DRAM, SRAM, non-volatile memory (e.g., flash memory), or other storage. In at least one embodiment, a choice of whether code and/or data storage 1005 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, code and/or code and/or data storage 1001 and code and/or data storage 1005 may be separate storage structures. In at least one embodiment, code and/or data storage 1001 and code and/or data storage 1005 may be a combined storage structure. In at least one embodiment, code and/or data storage 1001 and code and/or data storage 1005 may be partially combined and partially separate. In at least one embodiment, any portion of code and/or data storage 1001 and code and/or data storage 1005 may be included with other on-chip or off-chip data storage, including a processor's L1, L2, or L3 cache or system memory.

In at least one embodiment, inference and/or training logic 1015 may include, without limitation, one or more arithmetic logic unit(s) (“ALU(s)”) 1010, including integer and/or floating point units, to perform logical and/or mathematical operations based, at least in part on, or indicated by, training and/or inference code (e.g., graph code), a result of which may produce activations (e.g., output values from layers or neurons within a neural network) stored in an activation storage 1020 that are functions of input/output and/or weight parameter data stored in code and/or data storage 1001 and/or code and/or data storage 1005. In at least one embodiment, activations stored in activation storage 1020 are generated according to linear algebraic and/or matrix-based mathematics performed by ALU(s) 1010 in response to performing instructions or other code, wherein weight values stored in code and/or data storage 1005 and/or code and/or data storage 1001 are used as operands along with other values, such as bias values, gradient information, momentum values, or other parameters or hyperparameters, any or all of which may be stored in code and/or data storage 1005 or code and/or code and/or data storage 1001 or another storage on or off-chip.

In at least one embodiment, ALU(s) 1010 are included within one or more processors or other hardware logic devices or circuits, whereas in another embodiment, ALU(s) 1010 may be external to a processor or other hardware logic device or circuit that uses them (e.g., a co-processor). In at least one embodiment, ALU(s) 1010 may be included within a processor's execution units or otherwise within a bank of ALUs accessible by a processor's execution units either within the same processor or distributed between different processors of different types (e.g., central processing units, graphics processing units, fixed function units, etc.). In at least one embodiment, code and/or data storage 1001, code and/or data storage 1005, and activation storage 1020 may share a processor or other hardware logic device or circuit, whereas in another embodiment, they may be in different processors or other hardware logic devices or circuits, or some combination of same and different processors or other hardware logic devices or circuits. In at least one embodiment, any portion of activation storage 1020 may be included with other on-chip or off-chip data storage, including a processor's L1, L2, or L3 cache or system memory. Furthermore, inferencing and/or training code may be stored with other code accessible to a processor or other hardware logic or circuit and fetched and/or processed using a processor's fetch, decode, scheduling, execution, retirement and/or other logical circuits.

In at least one embodiment, activation storage 1020 may be cache memory, DRAM, SRAM, non-volatile memory (e.g., flash memory), or other storage. In at least one embodiment, activation storage 1020 may be completely or partially within or external to one or more processors or other logical circuits. In at least one embodiment, a choice of whether activation storage 1020 is internal or external to a processor, for example, or comprising DRAM, SRAM, flash memory or some other storage type may depend on available storage on-chip versus off-chip, latency requirements of training and/or inferencing functions being performed, batch size of data used in inferencing and/or training of a neural network, or some combination of these factors.

In at least one embodiment, inference and/or training logic 1015 illustrated in FIG. 10A may be used in conjunction with an application-specific integrated circuit (“ASIC”), such as a TensorFlow® Processing Unit from Google, an inference processing unit (IPU) from Graphcore™, or a Nervana® (e.g., “Lake Crest”) processor from Intel Corp. In at least one embodiment, inference and/or training logic 1015 illustrated in FIG. 10A may be used in conjunction with central processing unit (“CPU”) hardware, graphics processing unit (“GPU”) hardware or other hardware, such as field programmable gate arrays (“FPGAs”).

FIG. 10B illustrates inference and/or training logic 1015, according to at least one embodiment. In at least one embodiment, inference and/or training logic 1015 may include, without limitation, hardware logic in which computational resources are dedicated or otherwise exclusively used in conjunction with weight values or other information corresponding to one or more layers of neurons within a neural network. In at least one embodiment, inference and/or training logic 1015 illustrated in FIG. 10B may be used in conjunction with an application-specific integrated circuit (ASIC), such as TensorFlow® Processing Unit from Google, an inference processing unit (IPU) from Graphcore™, or a Nervana® (e.g., “Lake Crest”) processor from Intel Corp. In at least one embodiment, inference and/or training logic 1015 illustrated in FIG. 10B may be used in conjunction with central processing unit (CPU) hardware, graphics processing unit (GPU) hardware or other hardware, such as field programmable gate arrays (FPGAs). In at least one embodiment, inference and/or training logic 1015 includes, without limitation, code and/or data storage 1001 and code and/or data storage 1005, which may be used to store code (e.g., graph code), weight values and/or other information, including bias values, gradient information, momentum values, and/or other parameter or hyperparameter information. In at least one embodiment illustrated in FIG. 10B, each of code and/or data storage 1001 and code and/or data storage 1005 is associated with a dedicated computational resource, such as computational hardware 1002 and computational hardware 1006, respectively. In at least one embodiment, each of computational hardware 1002 and computational hardware 1006 comprises one or more ALUs that perform mathematical functions, such as linear algebraic functions, only on information stored in code and/or data storage 1001 and code and/or data storage 1005, respectively, the result of which is stored in activation storage 1020.

In at least one embodiment, each of code and/or data storage 1001 and 1005 and corresponding computational hardware 1002 and 1006, respectively, correspond to different layers of a neural network, such that resulting activation from one storage/computational pair 1001/1002 of code and/or data storage 1001 and computational hardware 1002 is provided as an input to a next storage/computational pair 1005/1006 of code and/or data storage 1005 and computational hardware 1006, in order to mirror a conceptual organization of a neural network. In at least one embodiment, each of storage/computational pairs 1001/1002 and 1005/1006 may correspond to more than one neural network layer. In at least one embodiment, additional storage/computation pairs (not shown) subsequent to or in parallel with storage/computation pairs 1001/1002 and 1005/1006 may be included in inference and/or training logic 1015.

### Neural Network Training and Deployment

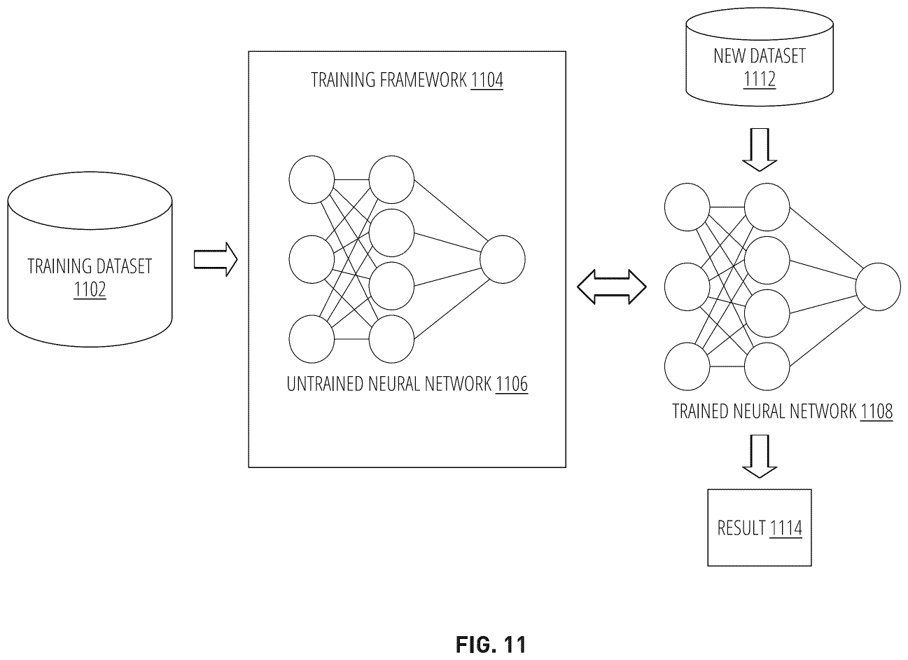

FIG. 11 illustrates training and deployment of a deep neural network, according to at least one embodiment. In at least one embodiment, untrained neural network 1106 is trained using a training dataset 1102. In at least one embodiment, training framework 1104 is a PyTorch framework, whereas in other embodiments, training framework 1104 is a TensorFlow, Boost, Caffe, Microsoft Cognitive Toolkit/CNTK, MXNet, Chainer, Keras, Deeplearning4j, or other training framework. In at least one embodiment, training framework 1104 trains an untrained neural network 1106 and enables it to be trained using processing resources described herein to generate a trained neural network 1108. In at least one embodiment, weights may be chosen randomly or by pre-training using a deep belief network. In at least one embodiment, training may be performed in either a supervised, partially supervised, or unsupervised manner.

In at least one embodiment, untrained neural network 1106 is trained using supervised learning, wherein training dataset 1102 includes an input paired with a desired output for an input, or where training dataset 1102 includes input having a known output and an output of neural network 1106 is manually graded. In at least one embodiment, untrained neural network 1106 is trained in a supervised manner and processes inputs from training dataset 1102 and compares resulting outputs against a set of expected or desired outputs. In at least one embodiment, errors are then propagated back through untrained neural network 1106. In at least one embodiment, training framework 1104 adjusts weights that control untrained neural network 1106. In at least one embodiment, training framework 1104 includes tools to monitor how well untrained neural network 1106 is converging towards a model, such as trained neural network 1108, suitable to generating correct answers, such as in result 1114, based on input data such as a new dataset 1112. In at least one embodiment, training framework 1104 trains untrained neural network 1106 repeatedly while adjusting weights to refine an output of untrained neural network 1106 using a loss function and adjustment algorithm, such as stochastic gradient descent. In at least one embodiment, training framework 1104 trains untrained neural network 1106 until untrained neural network 1106 achieves a desired accuracy. In at least one embodiment, trained neural network 1108 can then be deployed to implement any number of machine learning operations.

In at least one embodiment, untrained neural network 1106 is trained using unsupervised learning, wherein untrained neural network 1106 attempts to train itself using unlabeled data. In at least one embodiment, unsupervised learning training dataset 1102 will include input data without any associated output data or “ground truth” data. In at least one embodiment, untrained neural network 1106 can learn groupings within training dataset 1102 and can determine how individual inputs are related to untrained dataset 1102. In at least one embodiment, unsupervised training can be used to generate a self-organizing map in trained neural network 1108 capable of performing operations useful in reducing dimensionality of new dataset 1112. In at least one embodiment, unsupervised training can also be used to perform anomaly detection, which allows identification of data points in new dataset 1112 that deviate from normal patterns of new dataset 1112.

In at least one embodiment, semi-supervised learning may be used, which is a technique in which training dataset 1102 includes a mix of labeled and unlabeled data. In at least one embodiment, training framework 1104 may be used to perform incremental learning, such as through transferred learning techniques. In at least one embodiment, incremental learning enables trained neural network 1108 to adapt to new dataset 1112 without forgetting knowledge instilled within trained neural network 1108 during initial training.

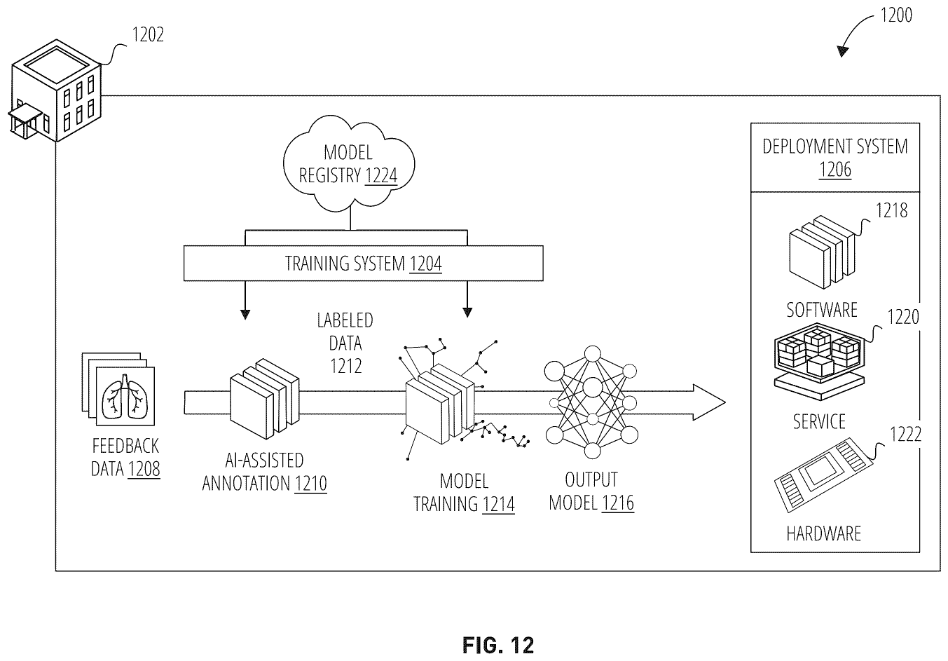

With reference to FIG. 12, FIG. 12 is an example data flow diagram for a process 1200 of generating and deploying a processing and inferencing pipeline, according to at least one embodiment. In at least one embodiment, process 1200 may be deployed to perform game name recognition analysis and inferencing on user feedback data at one or more facilities 1202, such as a data center.

In at least one embodiment, process 1200 may be executed within a training system 1204 and/or a deployment system 1206. In at least one embodiment, training system 1204 may be used to perform training, deployment, and embodiment of machine learning models (e.g., neural networks, object detection algorithms, computer vision algorithms, etc.) for use in deployment system 1206. In at least one embodiment, deployment system 1206 may be configured to offload processing and compute resources among a distributed computing environment to reduce infrastructure requirements at facility 1202. In at least one embodiment, deployment system 1206 may provide a streamlined platform for selecting, customizing, and implementing virtual instruments for use with computing devices at facility 1202. In at least one embodiment, virtual instruments may include software-defined applications for performing one or more processing operations with respect to feedback data. In at least one embodiment, one or more applications in a pipeline may use or call upon services (e.g., inference, visualization, compute, AI, etc.) of deployment system 1206 during execution of applications.

In at least one embodiment, some applications used in advanced processing and inferencing pipelines may use machine learning models or other AI to perform one or more processing steps. In at least one embodiment, machine learning models may be trained at facility 1202 using feedback data 1208 (such as imaging data) stored at facility 1202 or feedback data 1208 from another facility or facilities, or a combination thereof. In at least one embodiment, training system 1204 may be used to provide applications, services, and/or other resources for generating working, deployable machine learning models for deployment system 1206.

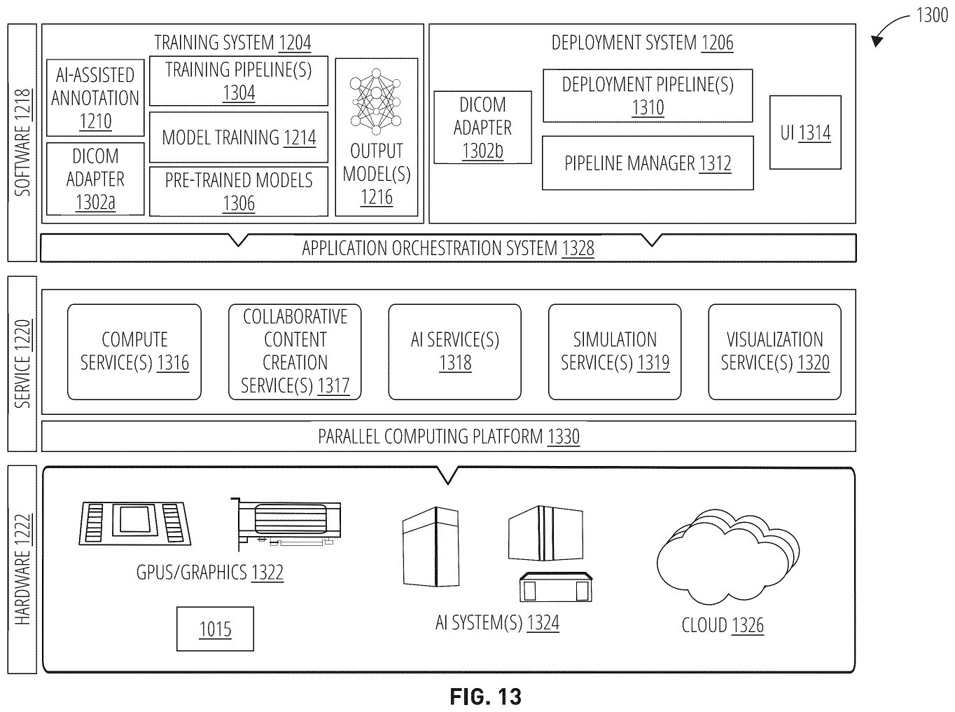

In at least one embodiment, a model registry 1224 may be backed by object storage that may support versioning and object metadata. In at least one embodiment, object storage may be accessible through, for example, a cloud storage (e.g., a cloud 1326 of FIG. 13) compatible application programming interface (API) from within a cloud platform. In at least one embodiment, machine learning models within model registry 1224 may be uploaded, listed, modified, or deleted by developers or partners of a system interacting with an API. In at least one embodiment, an API may provide access to methods that allow users with appropriate credentials to associate models with applications, such that models may be executed as part of execution of containerized instantiations of applications.

In at least one embodiment, a training pipeline(s) 1304 (FIG. 13) may include a scenario where facility 1202 is training their own machine learning model or has an existing machine learning model that needs to be optimized or updated. In at least one embodiment, feedback data 1208 may be received from various channels, such as forums, web forms, or the like. In at least one embodiment, once feedback data 1208 is received, AI-assisted annotation 1210 may be used to aid in generating annotations corresponding to feedback data 1208 to be used as ground truth data for a machine learning model. In at least one embodiment, AI-assisted annotation 1210 may include one or more machine learning models (e.g., convolutional neural networks (CNNs)) that may be trained to generate annotations corresponding to certain types of feedback data 1208 (e.g., from certain devices) and/or certain types of anomalies in feedback data 1208. In at least one embodiment, AI-assisted annotations 1210 may then be used directly, or may be adjusted or fine-tuned using an annotation tool, to generate ground truth data. In at least one embodiment, in some examples, labeled data 1212 may be used as ground truth data for training a machine learning model. In at least one embodiment, AI-assisted annotations 1210, labeled data 1212, or a combination thereof may be used as ground truth data for training a machine learning model, e.g., via model training 1214 in FIG. 12 and/or FIG. 13. In at least one embodiment, a trained machine learning model may be referred to as an output model 1216, and may be used by deployment system 1206, as described herein.

In at least one embodiment, training pipeline(s) 1304 (FIG. 13) may include a scenario where facility 1202 needs a machine learning model for use in performing one or more processing tasks for one or more applications in deployment system 1206, but facility 1202 may not currently have such a machine learning model (or may not have a model that is optimized, efficient, or effective for such purposes). In at least one embodiment, an existing machine learning model may be selected from model registry 1224. In at least one embodiment, model registry 1224 may include machine learning models trained to perform a variety of different inference tasks on imaging data. In at least one embodiment, machine learning models in model registry 1224 may have been trained on imaging data from different facilities than facility 1202 (e.g., facilities that are remotely located). In at least one embodiment, machine learning models may have been trained on imaging data from one location, two locations, or any number of locations. In at least one embodiment, when being trained on imaging data, which may be a form of feedback data 1208, from a specific location, training may take place at that location, or at least in a manner that protects confidentiality of imaging data or restricts imaging data from being transferred off-premises (e.g., to comply with HIPAA regulations, privacy regulations, etc.). In at least one embodiment, once a model is trained—or partially trained—at one location, a machine learning model may be added to model registry 1224. In at least one embodiment, a machine learning model may then be retrained, or updated, at any number of other facilities, and a retrained or updated model may be made available in model registry 1224. In at least one embodiment, a machine learning model may then be selected from model registry 1224—and referred to as output model(s) 1216—and may be used in deployment system 1206 to perform one or more processing tasks for one or more applications of a deployment system.

In at least one embodiment, training pipeline(s) 1304 (FIG. 13) may be used in a scenario that includes facility 1202 requiring a machine learning model for use in performing one or more processing tasks for one or more applications in deployment system 1206, but facility 1202 may not currently have such a machine learning model (or may not have a model that is optimized, efficient, or effective for such purposes). In at least one embodiment, a machine learning model selected from model registry 1224 might not be fine-tuned or optimized for feedback data 1208 generated at facility 1202 because of differences in populations, genetic variations, robustness of training data used to train a machine learning model, diversity in anomalies of training data, and/or other issues with training data. In at least one embodiment, AI-assisted annotation 1210 may be used to aid in generating annotations corresponding to feedback data 1208 to be used as ground truth data for retraining or updating a machine learning model. In at least one embodiment, labeled data 1212 may be used as ground truth data for training a machine learning model. In at least one embodiment, retraining or updating a machine learning model may be referred to as model training 1214. In at least one embodiment, model training 1214 may include data—e.g., AI-assisted annotations 1210, labeled data 1212, or a combination thereof—that may be used as ground truth data for retraining or updating a machine learning model.

In at least one embodiment, deployment system 1206 may include software 1218, service 1220, hardware 1222, and/or other components, features, and functionality. In at least one embodiment, deployment system 1206 may include a software “stack,” such that software 1218 may be built on top of service 1220 and may use service 1220 to perform some or all of processing tasks, and service 1220 and software 1218 may be built on top of hardware 1222 and use hardware 1222 to execute processing, storage, and/or other compute tasks of deployment system 1206.

In at least one embodiment, software 1218 may include any number of different containers, where each container may execute an instantiation of an application. In at least one embodiment, each application may perform one or more processing tasks in an advanced processing and inferencing pipeline (e.g., inferencing, object detection, feature detection, segmentation, image enhancement, calibration, etc.). In at least one embodiment, for each type of computing device there may be any number of containers that may perform a data processing task with respect to feedback data 1208 (or other data types, such as those described herein). In at least one embodiment, an advanced processing and inferencing pipeline may be defined based on selections of different containers that are desired or required for processing feedback data 1208, in addition to containers that receive and configure imaging data for use by each container and/or for use by facility 1202 after processing through a pipeline (e.g., to convert outputs back to a usable data type for storage and display at facility 1202). In at least one embodiment, a combination of containers within software 1218 (e.g., that make up a pipeline) may be referred to as a virtual instrument (as described in more detail herein), and a virtual instrument may leverage service 1220 and hardware 1222 to execute some or all processing tasks of applications instantiated in containers.

In at least one embodiment, data may undergo pre-processing as part of data processing pipeline to prepare data for processing by one or more applications. In at least one embodiment, post-processing may be performed on an output of one or more inferencing tasks or other processing tasks of a pipeline to prepare an output data for a next application and/or to prepare output data for transmission and/or use by a user (e.g., as a response to an inference request). In at least one embodiment, inferencing tasks may be performed by one or more machine learning models, such as trained or deployed neural networks, which may include output model(s) 1216 of training system 1204.

In at least one embodiment, tasks of data processing pipeline may be encapsulated in one or more container(s) that each represent a discrete, fully functional instantiation of an application and virtualized computing environment that is able to reference machine learning models. In at least one embodiment, containers or applications may be published into a private (e.g., limited access) area of a container registry (described in more detail herein), and trained or deployed models may be stored in model registry 1224 and associated with one or more applications. In at least one embodiment, images of applications (e.g., container images) may be available in a container registry, and once selected by a user from a container registry for deployment in a pipeline, an image may be used to generate a container for an instantiation of an application for use by a user system.

In at least one embodiment, developers may develop, publish, and store applications (e.g., as containers) for performing processing and/or inferencing on supplied data. In at least one embodiment, development, publishing, and/or storing may be performed using a software development kit (SDK) associated with a system (e.g., to ensure that an application and/or container developed is compliant with or compatible with a system). In at least one embodiment, an application that is developed may be tested locally (e.g., at a first facility, on data from a first facility) with an SDK which may support at least some of services 1220 as a system (e.g., system 1300 of FIG. 13). In at least one embodiment, once validated by system 1300 (e.g., for accuracy, etc.), an application may be available in a container registry for selection and/or embodiment by a user (e.g., a hospital, clinic, lab, healthcare provider, etc.) to perform one or more processing tasks with respect to data at a facility (e.g., a second facility) of a user.

In at least one embodiment, developers may then share applications or containers through a network for access and use by users of a system (e.g., system 1300 of FIG. 13). In at least one embodiment, completed and validated applications or containers may be stored in a container registry and associated machine learning models may be stored in model registry 1224. In at least one embodiment, a requesting entity that provides an inference or image processing request may browse a container registry and/or model registry 1224 for an application, container, dataset, machine learning model, etc., select a desired combination of elements for inclusion in data processing pipeline, and submit a processing request. In at least one embodiment, a request may include input data that is necessary to perform a request, and/or may include a selection of application(s) and/or machine learning models to be executed in processing a request. In at least one embodiment, a request may then be passed to one or more components of deployment system 1206 (e.g., a cloud) to perform processing of a data processing pipeline. In at least one embodiment, processing by deployment system 1206 may include referencing selected elements (e.g., applications, containers, models, etc.) from a container registry and/or model registry 1224. In at least one embodiment, once results are generated by a pipeline, results may be returned to a user for reference (e.g., for viewing in a viewing application suite executing on a local, on-premises workstation or terminal).

In at least one embodiment, to aid in processing or execution of applications or containers in pipelines, service 1220 may be leveraged. In at least one embodiment, service 1220 may include compute services, collaborative content creation services, simulation services, artificial intelligence (AI) services, visualization services, and/or other service types. In at least one embodiment, service 1220 may provide functionality that is common to one or more applications in software 1218, so functionality may be abstracted to a service that may be called upon or leveraged by applications. In at least one embodiment, functionality provided by service 1220 may run dynamically and more efficiently, while also scaling well by allowing applications to process data in parallel, e.g., using a parallel computing platform 1330 (FIG. 13). In at least one embodiment, rather than each application that shares a same functionality offered by a service 1220 being required to have a respective instance of service 1220, service 1220 may be shared between and among various applications. In at least one embodiment, services may include an inference server or engine that may be used for executing detection or segmentation tasks, as non-limiting examples. In at least one embodiment, a model training service may be included that may provide machine learning model training and/or retraining capabilities.

In at least one embodiment, where a service 1220 includes an AI service (e.g., an inference service), one or more machine learning models associated with an application for anomaly detection (e.g., tumors, growth abnormalities, scarring, etc.) may be executed by calling upon (e.g., as an API call) an inference service (e.g., an inference server) to execute machine learning model(s), or processing thereof, as part of application execution. In at least one embodiment, where another application includes one or more machine learning models for segmentation tasks, an application may call upon an inference service to execute machine learning models for performing one or more processing operations associated with segmentation tasks. In at least one embodiment, software 1218 implementing advanced processing and inferencing pipeline may be streamlined because each application may call upon the same inference service to perform one or more inferencing tasks.

In at least one embodiment, hardware 1222 may include GPUs, CPUs, data processing units (DPUs), an AI/deep learning system (e.g., an AI supercomputer, such as NVIDIA's DGX™ supercomputer system), a cloud platform, or a combination thereof. In at least one embodiment, different types of hardware 1222 may be used to provide efficient, purpose-built support for software 1218 and service 1220 in deployment system 1206. In at least one embodiment, use of GPU processing may be implemented for processing locally (e.g., at facility 1202), within an AI/deep learning system, in a cloud system, and/or in other processing components of deployment system 1206 to improve efficiency, accuracy, and efficacy of game name recognition.

In at least one embodiment, software 1218 and/or service 1220 may be optimized for GPU processing with respect to deep learning, machine learning, and/or high-performance computing, simulation, and visual computing, as non-limiting examples. In at least one embodiment, at least some of the computing environment of deployment system 1206 and/or training system 1204 may be executed in a datacenter or one or more supercomputers or high performance computing systems, with GPU-optimized software (e.g., hardware and software combination of NVIDIA's DGX™ system). In at least one embodiment, hardware 1222 may include any number of GPUs that may be called upon to perform processing of data in parallel, as described herein. In at least one embodiment, cloud platform may further include GPU processing for GPU-optimized execution of deep learning tasks, machine learning tasks, or other computing tasks. In at least one embodiment, cloud platform (e.g., NVIDIA's NGC™) may be executed using an AI/deep learning supercomputer(s) and/or GPU-optimized software (e.g., as provided on NVIDIA's DGX™ systems) as a hardware abstraction and scaling platform. In at least one embodiment, cloud platform may integrate an application container clustering system or orchestration system (e.g., KUBERNETES) on multiple GPUs to enable seamless scaling and load balancing.

FIG. 13 is a system diagram for an example system 1300 for generating and deploying a deployment pipeline, according to at least one embodiment. In at least one embodiment, system 1300 may be used to implement process 1200 of FIG. 12 and/or other processes including advanced processing and inferencing pipelines. In at least one embodiment, system 1300 may include training system 1204 and deployment system 1206. In at least one embodiment, training system 1204 and deployment system 1206 may be implemented using software 1218, services 1220, and/or hardware 1222, as described herein.

In at least one embodiment, system 1300 (e.g., training system 1204 and/or deployment system 1206) may implemented in a cloud computing environment (e.g., using cloud 1326). In at least one embodiment, system 1300 may be implemented locally with respect to a facility, or as a combination of both cloud and local computing resources. In at least one embodiment, access to APIs in cloud 1326 may be restricted to authorized users through enacted security measures or protocols. In at least one embodiment, a security protocol may include web tokens that may be signed by an authentication (e.g., AuthN, AuthZ, Gluccon, etc.) service and may carry appropriate authorization. In at least one embodiment, APIs of virtual instruments (described herein), or other instantiations of system 1300, may be restricted to a set of public internet service providers (ISPs) that have been vetted or authorized for interaction.

In at least one embodiment, various components of system 1300 may communicate between and among one another using any of a variety of different network types, including but not limited to local area networks (LANs) and/or wide area networks (WANs) via wired and/or wireless communication protocols. In at least one embodiment, communication between facilities and components of system 1300 (e.g., for transmitting inference requests, for receiving results of inference requests, etc.) may be communicated over a data bus or data busses, wireless data protocols (e.g., Wi-Fi), wired data protocols (e.g., Ethernet), etc.

In at least one embodiment, training system 1204 may execute training pipelines 1304, similar to those described herein with respect to FIG. 12. In at least one embodiment, where one or more machine learning models are to be used in deployment pipeline(s) 1310 by deployment system 1206, training pipeline(s) 1304 may be used to train or retrain one or more (e.g., pre-trained) models, and/or implement one or more of pre-trained models 1306 (e.g., without a need for retraining or updating). In at least one embodiment, as a result of training pipeline(s) 1304, output model(s) 1216 may be generated. In at least one embodiment, training pipeline(s) 1304 may include any number of processing steps, AI-assisted annotation 1210, labeling or annotating of feedback data 1208 to generate labeled data 1212, model selection from a model registry, model training 1214, training, retraining, or updating models, and/or other processing steps. In at least one embodiment, DICOM adapter 1302a can be used to access DICOM data. In at least one embodiment, for different machine learning models used by deployment system 1206, different training pipeline(s) 1304 may be used. In at least one embodiment, training pipeline(s) 1304, similar to a first example described with respect to FIG. 12, may be used for a first machine learning model, training pipeline(s) 1304, similar to a second example described with respect to FIG. 12, may be used for a second machine learning model, and training pipeline(s) 1304, similar to a third example described with respect to FIG. 12, may be used for a third machine learning model. In at least one embodiment, any combination of tasks within training system 1204 may be used depending on what is required for each respective machine learning model. In at least one embodiment, one or more of machine learning models may already be trained and ready for deployment so machine learning models may not undergo any processing by training system 1204 and may be implemented by deployment system 1206.

In at least one embodiment, output model(s) 1216 and/or pre-trained models 1306 may include any types of machine learning models depending on embodiment. In at least one embodiment, and without limitation, machine learning models used by system 1300 may include machine learning model(s) using linear regression, logistic regression, decision trees, support vector machines (SVM), Naïve Bayes, k-nearest neighbor (Knn), K means clustering, random forest, dimensionality reduction algorithms, gradient boosting algorithms, neural networks (e.g., auto-encoders, convolutional, recurrent, perceptrons, Long/Short Term Memory (LSTM), Bi-LSTM, Hopfield, Boltzmann, deep belief, deconvolutional, generative adversarial, liquid state machine, etc.), and/or other types of machine learning models.

In at least one embodiment, training pipeline(s) 1304 may include AI-assisted annotation. In at least one embodiment, labeled data 1212 (e.g., traditional annotation) may be generated by any number of techniques. In at least one embodiment, labels or other annotations may be generated within a drawing program (e.g., an annotation program), a computer aided design (CAD) program, a labeling program, another type of program suitable for generating annotations or labels for ground truth, and/or may be hand drawn, in some examples. In at least one embodiment, ground truth data may be synthetically produced (e.g., generated from computer models or renderings), real produced (e.g., designed and produced from real-world data), machine-automated (e.g., using feature analysis and learning to extract features from data and then generate labels), human annotated (e.g., labeler, or annotation expert, defines location of labels), and/or a combination thereof. In at least one embodiment, for each instance of feedback data 1208 (or other data type used by machine learning models), there may be corresponding ground truth data generated by training system 1204. In at least one embodiment, AI-assisted annotation may be performed as part of deployment pipeline(s) 1310; either in addition to, or in lieu of, AI-assisted annotation included in training pipeline(s) 1304. In at least one embodiment, system 1300 may include a multi-layer platform that may include a software layer (e.g., software 1218) of diagnostic applications (or other application types) that may perform one or more medical imaging and diagnostic functions.

In at least one embodiment, a software layer may be implemented as a secure, encrypted, and/or authenticated API through which applications or containers may be invoked (e.g., called) from an external environment(s), e.g., facility 1202. In at least one embodiment, applications may then call or execute one or more services 1220 for performing compute, AI, or visualization tasks associated with respective applications, and software 1218 and/or services 1220 may leverage hardware 1222 to perform processing tasks in an effective and efficient manner.

In at least one embodiment, deployment system 1206 may execute deployment pipelines 1310. In at least one embodiment, deployment pipeline(s) 1310 may include any number of applications that may be sequentially, non-sequentially, or otherwise applied to feedback data (and/or other data types), including AI-assisted annotation, as described above. In at least one embodiment, as described herein, a deployment pipeline(s) 1310 for an individual device may be referred to as a virtual instrument for a device. In at least one embodiment, for a single device, there may be more than one deployment pipeline(s) 1310 depending on information desired from data generated by a device.

In at least one embodiment, applications available for deployment pipeline(s) 1310 may include any application that may be used for performing processing tasks on feedback data or other data from devices. In at least one embodiment, because various applications may share common image operations, in some embodiments, a data augmentation library (e.g., as one of services 1220) may be used to accelerate these operations. In at least one embodiment, to avoid bottlenecks of conventional processing approaches that rely on CPU processing, parallel computing platform 1330 may be used for GPU acceleration of these processing tasks.

In at least one embodiment, deployment system 1206 may include a user interface (UI) 1314 (e.g., a graphical user interface, a web interface, etc.) that may be used to select applications for inclusion in deployment pipeline(s) 1310, arrange applications, modify or change applications or parameters or constructs thereof, use and interact with deployment pipeline(s) 1310 during set-up and/or deployment, and/or to otherwise interact with deployment system 1206. In at least one embodiment, although not illustrated with respect to training system 1204, UI 1314 (or a different user interface) may be used for selecting models for use in deployment system 1206, for selecting models for training, or retraining, in training system 1204, and/or for otherwise interacting with training system 1204.

In at least one embodiment, pipeline manager 1312 may be used, in addition to an application orchestration system 1328, to manage interaction between applications or containers of deployment pipeline(s) 1310 and services 1220 and/or hardware 1222. In at least one embodiment, pipeline manager 1312 may be configured to facilitate interactions from application to application, from application to service 1220, and/or from application or service to hardware 1222. In at least one embodiment, although illustrated as included in software 1218, this is not intended to be limiting, and in some examples pipeline manager 1312 may be included in services 1220. In at least one embodiment, application orchestration system 1328 (e.g., Kubernetes, DOCKER, etc.) may include a container orchestration system that may group applications into containers as logical units for coordination, management, scaling, and deployment. In at least one embodiment, by associating applications from deployment pipeline(s) 1310 (e.g., a reconstruction application, a segmentation application, etc.) with individual containers, each application may execute in a self-contained environment (e.g., at a kernel level) to increase speed and efficiency.

In at least one embodiment, each application and/or container (or image thereof) may be individually developed, modified, and deployed (e.g., a first user or developer may develop, modify, and deploy a first application and a second user or developer may develop, modify, and deploy a second application separate from a first user or developer), which may allow for focus on, and attention to, a task of a single application and/or container(s) without being hindered by tasks of other application(s) or container(s). In at least one embodiment, communication, and cooperation between different containers or applications may be aided by pipeline manager 1312 and application orchestration system 1328. In at least one embodiment, so long as an expected input and/or output of each container or application is known by a system (e.g., based on constructs of applications or containers), application orchestration system 1328 and/or pipeline manager 1312 may facilitate communication among and between, and sharing of resources among and between, each of the applications or containers. In at least one embodiment, because one or more of applications or containers in deployment pipeline(s) 1310 may share the same services and resources, application orchestration system 1328 may orchestrate, load balance, and determine sharing of services or resources between and among various applications or containers. In at least one embodiment, a scheduler may be used to track resource requirements of applications or containers, current usage or planned usage of these resources, and resource availability. In at least one embodiment, the scheduler may thus allocate resources to different applications and distribute resources between and among applications in view of requirements and availability of a system. In some examples, the scheduler (and/or other component of application orchestration system 1328) may determine resource availability and distribution based on constraints imposed on a system (e.g., user constraints), such as quality of service (QOS), urgency of need for data outputs (e.g., to determine whether to execute real-time processing or delayed processing), etc.

In at least one embodiment, services 1220 leveraged and shared by applications or containers in deployment system 1206 may include compute service(s) 1316, collaborative content creation service(s) 1317, AI service(s) 1318, simulation service(s) 1319, visualization service(s) 1320, and/or other service types. In at least one embodiment, applications may call (e.g., execute) one or more of services 1220 to perform processing operations for an application. In at least one embodiment, compute service(s) 1316 may be leveraged by applications to perform super-computing or other high-performance computing (HPC) tasks. In at least one embodiment, compute service(s) 1316 may be leveraged to perform parallel processing (e.g., using a parallel computing platform 1330) for processing data through one or more of applications and/or one or more tasks of a single application, substantially simultaneously. In at least one embodiment, parallel computing platform 1330 (e.g., NVIDIA's CUDA®) may enable general purpose computing on GPUs (GPGPU) (e.g., GPUs/graphics 1322). In at least one embodiment, a software layer of parallel computing platform 1330 may provide access to virtual instruction sets and parallel computational elements of GPUs, for execution of compute kernels. In at least one embodiment, parallel computing platform 1330 may include memory and, in some embodiments, a memory may be shared between and among multiple containers and/or between and among different processing tasks within a single container. In at least one embodiment, inter-process communication (IPC) calls may be generated for multiple containers and/or for multiple processes within a container to use same data from a shared segment of memory of parallel computing platform 1330 (e.g., where multiple different stages of an application or multiple applications are processing same information). In at least one embodiment, rather than making a copy of data and moving data to different locations in memory (e.g., a read/write operation), same data in the same location of a memory may be used for any number of processing tasks (e.g., at the same time, at different times, etc.). In at least one embodiment, as data is used to generate new data as a result of processing, this information of a new location of data may be stored and shared between various applications. In at least one embodiment, location of data and a location of updated or modified data may be part of a definition of how a payload is understood within containers.

In at least one embodiment, AI service(s) 1318 may be leveraged to perform inferencing services for executing machine learning model(s) associated with applications (e.g., tasked with performing one or more processing tasks of an application). In at least one embodiment, AI service(s) 1318 may leverage AI system(s) 1324 to execute machine learning model(s) (e.g., neural networks, such as CNNs) for segmentation, reconstruction, object detection, feature detection, classification, and/or other inferencing tasks. In at least one embodiment, applications of deployment pipeline(s) 1310 may use one or more of output model(s) 1216 from training system 1204 and/or other models of applications to perform inference on imaging data (e.g., DICOM data, RIS data, CIS data, REST compliant data, RPC data, raw data, etc.). For example, DICOM adapter 1302b may be used to access DICOM data. In at least one embodiment, two or more examples of inferencing using application orchestration system 1328 (e.g., a scheduler) may be available. In at least one embodiment, a first category may include a high priority/low latency path that may achieve higher service level agreements, such as for performing inference on urgent requests during an emergency, or for a radiologist during diagnosis. In at least one embodiment, a second category may include a standard priority path that may be used for requests that may be non-urgent or where analysis may be performed at a later time. In at least one embodiment, application orchestration system 1328 may distribute resources (e.g., services 1220 and/or hardware 1222) based on priority paths for different inferencing tasks of AI service(s) 1318.

In at least one embodiment, shared storage may be mounted to AI service(s) 1318 within system 1300. In at least one embodiment, shared storage may operate as a cache (or other storage device type) and may be used to process inference requests from applications. In at least one embodiment, when an inference request is submitted, a request may be received by a set of API instances of deployment system 1206, and one or more instances may be selected (e.g., for best fit, for load balancing, etc.) to process a request. In at least one embodiment, to process a request, a request may be entered into a database, a machine learning model may be located from model registry 1224 if not already in a cache, a validation step may ensure an appropriate machine learning model is loaded into a cache (e.g., shared storage), and/or a copy of a model may be saved to a cache. In at least one embodiment, the scheduler (e.g., of pipeline manager 1312) may be used to launch an application that is referenced in a request if an application is not already running or if there are not enough instances of an application. In at least one embodiment, if an inference server is not already launched to execute a model, an inference server may be launched. In at least one embodiment, any number of inference servers may be launched per model. In at least one embodiment, in a pull model, in which inference servers are clustered, models may be cached whenever load balancing is advantageous. In at least one embodiment, inference servers may be statically loaded in corresponding, distributed servers.

In at least one embodiment, inferencing may be performed using an inference server that runs in a container. In at least one embodiment, an instance of an inference server may be associated with a model (and optionally a plurality of versions of a model). In at least one embodiment, if an instance of an inference server does not exist when a request to perform inference on a model is received, a new instance may be loaded. In at least one embodiment, when starting an inference server, a model may be passed to an inference server such that a same container may be used to serve different models so long as the inference server is running as a different instance.

In at least one embodiment, during application execution, an inference request for a given application may be received, and a container (e.g., hosting an instance of an inference server) may be loaded (if not already loaded), and a start procedure may be called. In at least one embodiment, pre-processing logic in a container may load, decode, and/or perform any additional pre-processing on incoming data (e.g., using a CPU(s) and/or GPU(s)). In at least one embodiment, once data is prepared for inference, a container may perform inference as necessary on data. In at least one embodiment, this may include a single inference call on one image (e.g., a hand X-ray), or may require inference on hundreds of images (e.g., a chest CT). In at least one embodiment, an application may summarize results before completing, which may include, without limitation, a single confidence score, pixel-level segmentation, voxel-level segmentation, generating a visualization, or generating text to summarize findings. In at least one embodiment, different models or applications may be assigned different priorities. For example, some models may have a real-time (turnaround time less than one minute) priority while others may have lower priority (e.g., turnaround less than 10 minutes). In at least one embodiment, model execution times may be measured from requesting institution or entity and may include partner network traversal time, as well as execution on an inference service.

In at least one embodiment, transfer of requests between services 1220 and inference applications may be hidden behind a software development kit (SDK), and robust transport may be provided through a queue. In at least one embodiment, a request is placed in a queue via an API for an individual application/tenant ID combination and an SDK pulls a request from a queue and gives a request to an application. In at least one embodiment, a name of a queue may be provided in an environment from where an SDK picks up the request. In at least one embodiment, asynchronous communication through a queue may be useful as it may allow any instance of an application to pick up work as it becomes available. In at least one embodiment, results may be transferred back through a queue, to ensure no data is lost. In at least one embodiment, queues may also provide an ability to segment work, as highest priority work may go to a queue with most instances of an application connected to it, while lowest priority work may go to a queue with a single instance connected to it that processes tasks in an order received. In at least one embodiment, an application may run on a GPU-accelerated instance generated in cloud 1326, and an inference service may perform inferencing on a GPU.

In at least one embodiment, visualization service(s) 1320 may be leveraged to generate visualizations for viewing outputs of applications and/or deployment pipeline(s) 1310. In at least one embodiment, GPUs/graphics 1322 may be leveraged by visualization service(s) 1320 to generate visualizations. In at least one embodiment, rendering effects, such as ray-tracing or other light transport simulation techniques, may be implemented by visualization service(s) 1320 to generate higher quality visualizations. In at least one embodiment, visualizations may include, without limitation, 2D image renderings, 3D volume renderings, 3D volume reconstruction, 2D tomographic slices, virtual reality displays, augmented reality displays, etc. In at least one embodiment, virtualized environments may be used to generate a virtual interactive display or environment (e.g., a virtual environment) for interaction by users of a system (e.g., doctors, nurses, radiologists, etc.). In at least one embodiment, visualization service(s) 1320 may include an internal visualizer, cinematics, and/or other rendering or image processing capabilities or functionality (e.g., ray tracing, rasterization, internal optics, etc.).

In at least one embodiment, hardware 1222 may include GPUs/graphics 1322, AI system(s) 1324, cloud 1326, and/or any other hardware used for executing training system 1204 and/or deployment system 1206. In at least one embodiment, GPUs/graphics 1322 (e.g., NVIDIA's TESLA® and/or QUADRO® GPUs) may include any number of GPUs that may be used for executing processing tasks of compute service(s) 1316, collaborative content creation service(s) 1317, AI service(s) 1318, simulation service(s) 1319, visualization service(s) 1320, other services, and/or any of features or functionality of software 1218. For example, with respect to AI service(s) 1318, GPUs/graphics 1322 may be used to perform pre-processing on imaging data (or other data types used by machine learning models), post-processing on outputs of machine learning models, and/or to perform inferencing (e.g., to execute machine learning models). In at least one embodiment, cloud 1326, AI system(s) 1324, and/or other components of system 1300 may use GPUs/graphics 1322. In at least one embodiment, cloud 1326 may include a GPU-optimized platform for deep learning tasks. In at least one embodiment, AI system(s) 1324 may use GPUs, and cloud 1326—or at least a portion tasked with deep learning or inferencing—may be executed using one or more AI system(s) s 1324. As such, although hardware 1222 is illustrated as discrete components, this is not intended to be limiting, and any components of hardware 1222 may be combined with, or leveraged by, any other components of hardware 1222.

In at least one embodiment, AI system(s) 1324 may include a purpose-built computing system (e.g., a super-computer or an HPC) configured for inferencing, deep learning, machine learning, and/or other artificial intelligence tasks. In at least one embodiment, AI system(s) 1324 (e.g., NVIDIA's DGX™) may include GPU-optimized software (e.g., a software stack) that may be executed using a plurality of GPUs/graphics 1322, in addition to CPUs, RAM, storage, and/or other components, features, or functionality. In at least one embodiment, one or more AI system(s) s 1324 may be implemented in cloud 1326 (e.g., in a data center) for performing some or all of AI-based processing tasks of system 1300.

In at least one embodiment, cloud 1326 may include a GPU-accelerated infrastructure (e.g., NVIDIA's NGC™) that may provide a GPU-optimized platform for executing processing tasks of system 1300. In at least one embodiment, cloud 1326 may include an AI system(s) 1324 for performing one or more of AI-based tasks of system 1300 (e.g., as a hardware abstraction and scaling platform). In at least one embodiment, cloud 1326 may integrate with application orchestration system 1328 leveraging multiple GPUs to enable seamless scaling and load balancing between and among applications and services 1220. In at least one embodiment, cloud 1326 may be tasked with executing at least some of services 1220 of system 1300, including compute service(s) 1316, AI service(s) 1318, and/or visualization service(s) 1320, as described herein. In at least one embodiment, cloud 1326 may perform small and large batch inference (e.g., executing NVIDIA's TensorRT™), provide an accelerated parallel computing platform 1330 (e.g., NVIDIA's CUDA®), execute application orchestration system 1328 (e.g., KUBERNETES), provide a graphics rendering API and platform (e.g., for ray-tracing, 2D graphics, 3D graphics, and/or other rendering techniques to produce higher quality cinematics), and/or may provide other functionality for system 1300. In at least one embodiment, parallel computing platform 1330 may include an API.

In at least one embodiment, in an effort to preserve patient confidentiality (e.g., where patient data or records are to be used off-premises), cloud 1326 may include a registry, such as a deep learning container registry. In at least one embodiment, a registry may store containers for instantiations of applications that may perform pre-processing, post-processing, or other processing tasks on patient data. In at least one embodiment, cloud 1326 may receive data that includes patient data as well as sensor data in containers, perform requested processing for just sensor data in those containers, and then forward a resultant output and/or visualizations to appropriate parties and/or devices (e.g., on-premises medical devices used for visualization or diagnoses), all without having to extract, store, or otherwise access patient data. In at least one embodiment, confidentiality of patient data is preserved in compliance with HIPAA and/or other data regulations.

Other variations are within the spirit of present disclosure. Thus, while disclosed techniques are susceptible to various modifications and alternative constructions, certain illustrated embodiments thereof are shown in drawings and have been described above in detail. It should be understood, however, that there is no intention to limit disclosure to specific form or forms disclosed, but on contrary, intention is to cover all modifications, alternative constructions, and equivalents falling within spirit and scope of disclosure, as defined in appended claims.

Use of terms “a” and “an” and “the” and similar referents in context of describing disclosed embodiments (especially in context of following claims) are to be construed to cover both singular and plural, unless otherwise indicated herein or clearly contradicted by context, and not as a definition of a term. Terms “comprising,” “having,” “including,” and “containing” are to be construed as open-ended terms (meaning “including, but not limited to,”) unless otherwise noted. “Connected,” when unmodified and referring to physical connections, is to be construed as partly or wholly contained within, attached to, or joined together, even if there is something intervening. Recitation of ranges of values herein are merely intended to serve as a shorthand method of referring individually to each separate value falling within range, unless otherwise indicated herein and each separate value is incorporated into specification as if it were individually recited herein. In at least one embodiment, use of the term “set” (e.g., “a set of items”) or “subset” unless otherwise noted or contradicted by context, is to be construed as a nonempty collection comprising one or more members. Further, unless otherwise noted or contradicted by context, the term “subset” of a corresponding set does not necessarily denote a proper subset of the corresponding set, but subset and corresponding set may be equal.

Conjunctive language, such as phrases of form “at least one of A, B, and C,” or “at least one of A, B and C,” unless specifically stated otherwise or otherwise clearly contradicted by context, is otherwise understood with context as used in general to present that an item, term, etc., may be either A or B or C, or any nonempty subset of set of A and B and C. For instance, in illustrative example of a set having three members, conjunctive phrases “at least one of A, B, and C” and “at least one of A, B and C” refer to any of following sets: {A}, {B}, {C}, {A, B}, {A, C}, {B, C}, {A, B, C}. Thus, such conjunctive language is not generally intended to imply that certain embodiments require at least one of A, at least one of B and at least one of C each to be present. In addition, unless otherwise noted or contradicted by context, the term “plurality” indicates a state of being plural (e.g., “a plurality of items” indicates multiple items). In at least one embodiment, a number of items in a plurality is at least two but can be more when so indicated either explicitly or by context. Further, unless stated otherwise or otherwise clear from context, the phrase “based on” means “based at least in part on” or “based at least on” and not “based solely on.”

Operations of processes described herein can be performed in any suitable order unless otherwise indicated herein or otherwise clearly contradicted by context. In at least one embodiment, a process such as those processes described herein (or variations and/or combinations thereof) is performed under control of one or more computer systems configured with executable instructions and is implemented as code (e.g., executable instructions, one or more computer programs or one or more applications) executing collectively on one or more processors, by hardware or combinations thereof. In at least one embodiment, code is stored on a computer-readable storage medium, for example, in the form of a computer program comprising a plurality of instructions executable by one or more processors. In at least one embodiment, a computer-readable storage medium is a non-transitory computer-readable storage medium that excludes transitory signals (e.g., a propagating transient electric or electromagnetic transmission) but includes non-transitory data storage circuitry (e.g., buffers, cache, and queues) within transceivers of transitory signals. In at least one embodiment, code (e.g., executable code or source code) is stored on a set of one or more non-transitory computer-readable storage media having stored thereon executable instructions (or other memory to store executable instructions) that, when executed (i.e., as a result of being executed) by one or more processors of a computer system, cause computer system to perform operations described herein. In at least one embodiment, set of non-transitory computer-readable storage media comprises multiple non-transitory computer-readable storage media and one or more of individual non-transitory storage media of multiple non-transitory computer-readable storage media lack all of code while multiple non-transitory computer-readable storage media collectively store all of code. In at least one embodiment, executable instructions are executed such that different instructions are executed by different processors—for example, a non-transitory computer-readable storage medium store instructions and a main central processing unit (“CPU”) executes some of instructions while a graphics processing unit (“GPU”) executes other instructions. In at least one embodiment, different components of a computer system have separate processors and different processors execute different subsets of instructions.

Accordingly, in at least one embodiment, computer systems are configured to implement one or more services that singly or collectively perform operations of processes described herein and such computer systems are configured with applicable hardware and/or software that enable performance of operations. Further, a computer system that implements at least one embodiment of present disclosure is a single device and, in another embodiment, is a distributed computer system comprising multiple devices that operate differently such that distributed computer system performs operations described herein and such that a single device does not perform all operations.

Use of any and all examples, or exemplary language (e.g., “such as”) provided herein, is intended merely to better illuminate embodiments of disclosure and does not pose a limitation on scope of disclosure unless otherwise claimed. No language in specification should be construed as indicating any non-claimed element as essential to practice of disclosure.

All references, including publications, patent applications, and patents, cited herein are hereby incorporated by reference to the same extent as if each reference were individually and specifically indicated to be incorporated by reference and were set forth in its entirety herein.

In description and claims, terms “coupled” and “connected,” along with their derivatives, may be used. It should be understood that these terms may be not intended as synonyms for each other. Rather, in particular examples, “connected” or “coupled” may be used to indicate that two or more elements are in direct or indirect physical or electrical contact with each other. “Coupled” may also mean that two or more elements are not in direct contact with each other, but yet still co-operate or interact with each other.

Unless specifically stated otherwise, in some embodiments, it may be appreciated that throughout specification terms such as “processing,” “computing,” “calculating,” “determining,” or like, refer to action and/or processes of a computer or computing system, or similar electronic computing device, that manipulate and/or transform data represented as physical, such as electronic, quantities within computing system's registers and/or memories into other data similarly represented as physical quantities within computing system's memories, registers or other such information storage, transmission or display devices.

In a similar manner, the term “processor” may refer to any device or portion of a device that processes electronic data from registers and/or memory and transforms that electronic data into other electronic data that may be stored in registers and/or memory. As non-limiting examples, “processor” may be a CPU or a GPU. A “computing platform” may comprise one or more processors. As used herein, “software” processes may include, for example, software and/or hardware entities that perform work over time, such as tasks, threads, and intelligent agents. Also, each process may refer to multiple processes, for carrying out instructions in sequence or in parallel, continuously or intermittently. In at least one embodiment, terms “system” and “method” are used herein interchangeably insofar as a system may embody one or more methods and methods may be considered a system.

In the present document, references may be made to obtaining, acquiring, receiving, or inputting analog or digital data into a subsystem, computer system, or computer-implemented machine. In at least one embodiment, a process of obtaining, acquiring, receiving, or inputting analog and digital data can be accomplished in a variety of ways such as by receiving data as a parameter of a function call or a call to an application programming interface. In at least one embodiment, processes of obtaining, acquiring, receiving, or inputting analog or digital data can be accomplished by transferring data via a serial or parallel interface. In at least one embodiment, processes of obtaining, acquiring, receiving, or inputting analog or digital data can be accomplished by transferring data via a computer network from providing entity to acquiring entity. In at least one embodiment, references may also be made to providing, outputting, transmitting, sending, or presenting analog or digital data. In various examples, processes of providing, outputting, transmitting, sending, or presenting analog or digital data can be accomplished by transferring data as an input or output parameter of a function call, a parameter of an application programming interface or interprocess communication mechanism.

Although descriptions herein set forth example embodiments of described techniques, other architectures may be used to implement described functionality, and are intended to be within scope of this disclosure. Furthermore, although specific distributions of responsibilities may be defined above for purposes of description, various functions and responsibilities might be distributed and divided in different ways, depending on circumstances.

Furthermore, although subject matter has been described in language specific to structural features and/or methodological acts, it is to be understood that subject matter claimed in appended claims is not necessarily limited to specific features or acts described. Rather, specific features and acts are disclosed as exemplary forms of implementing the claims.

What is claimed is:

1. A method of a parallel processing unit, the method comprising:
receiving first data of a first thread, the first data comprising a first input vector and a first matrix;
receiving second data of a second thread, the second data comprising a second input vector and a second matrix;
combining the first input vector and the second input vector into an input matrix;
generating a result matrix at least by multiplying the input matrix by the first matrix using a matrix-multiply circuit; and
separating the result matrix into a first result value and a second result value, the first result value corresponding to the first thread and the second result value corresponding to the second thread.

2. The method of claim 1, wherein the first matrix and the second matrix are the same.

3. The method of claim 1, wherein the first matrix and the second matrix are different, and wherein the generating the result matrix further comprises:
multiplying the input matrix by the second matrix using the matrix-multiply circuit to obtain a third matrix, wherein the result matrix comprises at least part of the third matrix.

4. The method of claim 1, wherein:
the first data further comprises a third matrix;
the multiplying the input matrix by the first matrix using the matrix-multiply circuit generates an intermediate matrix; and
the generating the result matrix further comprises:
multiplying the intermediate matrix by the third matrix using the matrix-multiply circuit to obtain a fourth matrix, wherein the result matrix comprises at least part of the fourth matrix.

5. The method of claim 4, wherein the generating the result matrix further comprises:
prior to the multiplying the input matrix by the first matrix, transforming the input matrix from an input format to a matrix-multiply format; and
transforming the result matrix from the matrix-multiply format to the input format.

6. The method of claim 5, wherein the intermediate matrix is in the matrix-multiply format, and wherein the generating the result matrix further comprises applying an activation function to the intermediate matrix.

7. The method of claim 1, wherein the generating the result matrix further comprises combining the result matrix with a third matrix.

8. The method of claim 1, wherein the input matrix comprises the first input vector, the second input vector, and one or more padding values.

9. The method of claim 1, wherein first values of the first input vector have a first bit length and second values of the first matrix have a second bit length, and wherein the first bit length and the second bit length are different.

10. A system comprising:
a memory comprising first data of a first thread and second data of a second thread, wherein the first data of the first thread comprises a first input vector and a first matrix and the second data of the second thread comprises a second input vector and a second matrix; and
a parallel processing unit communicatively coupled to the memory to perform operations comprising:
combining the first input vector and the second input vector into an input matrix;
generating a result matrix at least by multiplying the input matrix by the first matrix using a matrix-multiply circuit; and
separating the result matrix into a first result value and a second result value, the first result value corresponding to the first thread and the second result value corresponding to the second thread.

11. The system of claim 10, wherein the first matrix and the second matrix are the same.

12. The system of claim 10, wherein the first matrix and the second matrix are different, and wherein the generating the result matrix further comprises:
multiplying the input matrix by the second matrix using the matrix-multiply circuit to obtain a third matrix, wherein the result matrix comprises at least part of the third matrix.

13. The system of claim 10, wherein:
the first data further comprises a third matrix;
the multiplying the input matrix by the first matrix using the matrix-multiply circuit generates an intermediate matrix; and
the generating the result matrix further comprises:
multiplying the intermediate matrix by the third matrix using the matrix-multiply circuit to obtain a fourth matrix, wherein the result matrix comprises at least part of the fourth matrix.

14. The system of claim 13, wherein the generating the result matrix further comprises:
prior to the multiplying the input matrix by the first matrix, transforming the input matrix from an input format to a matrix-multiply format; and
transforming the result matrix from the matrix-multiply format to the input format.

15. The system of claim 10, wherein the generating the result matrix further comprises combining the result matrix with a third matrix.

16. The system of claim 10, wherein the input matrix comprises the first input vector, the second input vector, and one or more padding values.

17. The system of claim 10, wherein first values of the first input vector have a first bit length and second values of the first matrix have a second bit length, and wherein the first bit length and the second bit length are different.

18. A method comprising:
receiving a source code identifying one or more vector-matrix multiply operations to be performed by a plurality of threads;
compiling the source code into an executable code comprising instructions that cause a parallel processing unit to:
combine vectors from at least a subset of the one or more vector-matrix multiply operations into an input matrix;
multiply the input matrix by a first matrix using a matrix-multiply circuit to obtain a result matrix, the first matrix corresponding to at least a first vector-matrix multiply operation of the one or more vector-matrix multiply operations; and
separate the result matrix into a plurality of result values, each result value of the plurality of result values corresponding to a thread of the plurality of threads; and
causing the executable code to be executed by a parallel processing unit.

19. The method of claim 18, wherein the instructions further cause the parallel processing unit to:
prior to multiplying the input matrix by the first matrix, shuffle the input matrix from an input format to a matrix-multiply format; and
prior to separating the result matrix into the plurality of result values, shuffle the result matrix from the matrix-multiply format to the input format.

20. The method of claim 19, wherein the instructions further cause the parallel processing unit to, prior to shuffling the result matrix from the matrix-multiply format to the input format, apply an activation function to the result matrix in the matrix-multiply format.
